(19) United States
(12) Patent Application Publication
(10) Pub. No.: US 2015/0005440 A1
(43) Pub. Date: Jan. 1, 2015

(54) CONJUGATED DIENE POLYMER PRODUCTION METHOD, AND CONJUGATED DIENE POLYMER COMPOSITION PRODUCTION METHOD

(71) Applicant: Sumitomo Chemical Company, Limited, Tokyo (JP)

(72) Inventor: Mana Fujii, Gateway West (SG)

(73) Assignee: Sumitomo Chemical Company, Limited, Tokyo (JP)

(21) Appl. No.: 14/377,547

(22) PCT Filed: Jan. 31, 2013
(86) PCT No.: PCT/JP2013/052777

§ 371 Date: Aug. 8, 2014

(30) Foreign Application Priority Data
Feb. 10, 2012 (JP) 2012-027004

(51) Int. Cl. C08F 236/06; C08J 3/20

(52) U.S. Cl. CPC C08F 236/06; C08J 3/203; C08J 2309/06
USPC 524/547; 525/279

(57) ABSTRACT

A method for producing a conjugated diene-based polymer is provided, in which compounds of formulas (2) and (3) and a conjugated diene compound are polymerized using a compound of formula (1), and then a compound containing a nitrogen atom and/or a silicon atom is reacted with an active end of the polymer formed via the polymerization,

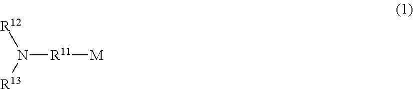

R¹¹ represents a hydrocarbylene group, R¹² and R¹³ each represent an optionally substituted hydrocarbyl group or a trihydrocarbylsilyl group, or R¹² is bonded to R³ and the group in which R¹² is bonded to R¹³ represents a hydrocarbylene group optionally having a nitrogen and/or oxygen atom, —Si(R¹⁴)₂—(CH₂)ₓ—Si(R¹⁴)₂—, or —Si(R¹⁵)₂—(CH₂)_{y}⁻, and M represents an alkali metal atom,

E²-A² (2)

E³-A³ (3)
E² and E³ each represent a hydrocarbyl group having a polymerizable carbon-carbon double bond, A² represents a substituted amino group or a nitrogen-containing heterocyclic group, and A³ represents a substituted silyl group.

### TECHNICAL FIELD

The present invention relates to a method for producing a conjugated diene-based polymer and a method for producing a conjugated diene-based polymer composition.

### BACKGROUND ART

As a rubber composition for automobile tires, a rubber composition containing a conjugated diene-based polymer such as polybutadiene or a butadiene-styrene copolymer, and a reinforcing agent is used.

In recent years, with an increase in concern about environmental problems, requirements of fuel cost saving properties on an automobile have been increasing, and a rubber composition used in tires for automobiles has also been required to be excellent in fuel cost saving.

For example, in JP-A-2010-77413 are proposed a conjugated diene-based polymer in which one end of a polymer obtained by living anion polymerization of butadiene, styrene and bis(diethylamino)methylvinylsilane using an alkyllithium as a polymerization initiator has been modified with N-(3-dimethylaminopropyl)acrylamide, and a polymer composition composed of this conjugated diene-based polymer and a reinforcing agent. In JP-A-2004-277696 are proposed a conjugated diene-based polymer in which one end of a polymer obtained by living anion polymerization of butadiene and styrene in the presence of a compound produced by reacting an isoprene monomer to 3-(N,N-dimethylamino)-1-propyllithium has been modified with N-(3-dimethylaminopropyl)acrylamide, and a polymer composition composed of this conjugated diene-based polymer and a reinforcing agent. In JP-A-7-82422 are proposed a polymer obtained by living anion polymerization of butadiene, styrene and (1-pyrrolidinyl)methylstyrene using a polymerization initiator made of an alkyllithium, and a polymer composition comprising that polymer and a reinforcing agent.

### DISCLOSURE OF THE INVENTION

However, polymer compositions using the above conventional conjugated diene-based polymer were not necessarily sufficiently satisfactory in fuel cost saving properties.

Under such circumstances, a problem to be solved by the present invention is to provide a method for producing a conjugated diene-based polymer useful for the preparation of a conjugated diene-based polymer composition excellent in fuel cost saving properties, and a method for producing a polymer composition containing a conjugated diene-based polymer obtained with this production method and a reinforcing agent.

### Means for Solving the Problems

A first aspect of the present invention relates to a method for producing a conjugated diene-based polymer, comprising polymerizing monomers including a compound represented by the following formula (2), a compound represented by the following formula (3) and a conjugated diene compound using a compound represented by the following formula (1), and then reacting a compound containing a nitrogen atom and/or a silicon atom to an active end of the polymer formed via the polymerization,

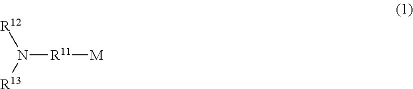

in formula (1), R¹¹ represents a hydrocarbylene group having 6 to 100 carbon atoms, R¹² and R¹³ each represent a hydrocarbyl group that optionally has a substituent or a trihydrocarbylsilyl group, or R¹² is bonded to R¹³ and the group in which R¹² is bonded to R¹³ represents a hydrocarbylene group optionally having a nitrogen atom and/or an oxygen atom as a hetero atom, a group having 5 to 20 carbon atoms represented by —Si(R¹⁴)₂—(CH₂)ₓ—Si(R¹⁴)₂— (R¹⁴ represents a hydrocarbyl group, and x represents an integer of 1 to 10), a group having 4 to 20 carbon atoms represented by —Si(R¹⁵)₂—(CH₂)_{y}— (R¹⁵ represents a hydrocarbyl group, and y represents an integer of 2 to 11), and M represents an alkali metal atom,

E²-A² (2)

wherein E² represents a hydrocarbyl group having a polymerizable carbon-carbon double bond, and A² represents a substituted amino group or a nitrogen-containing heterocyclic group,

E³-A³ (3)

wherein E³ represents a hydrocarbyl group having a polymerizable carbon-carbon double bond, and A³ represents a substituted silyl group.

A second aspect of the present invention relates to a method for producing a conjugated diene-based polymer composition, the method comprising a step of kneading 100 part by weight of a conjugated diene-based polymer obtained by the above-mentioned method with 10 parts by weight to 150 parts by weight of a reinforcing agent.

### MODE FOR CARRYING OUT THE INVENTION

Herein, a hydrocarbyl group represents a monovalent group obtained by removing one hydrogen atom from a hydrocarbon. A hydrocarbylene group represents a divalent group obtained by removing two hydrogen atoms from a hydrocarbon. A hydrocarbyloxy group represents a monovalent group having a structure in which a hydrogen atom of a hydroxy group is replaced with a hydrocarbyl group. An amino group having a substituent (hereinafter sometimes referred as a substituted amino group) a substituted amino group represents a group having a structure in which at least one hydrogen atom of an amino group is replaced with a monovalent atom other than a hydrogen atom or a monovalent group, or a group having a structure in which two hydrogen atoms of an amino group are replaced with a divalent group. A hydrocarbyl group having a substituent (hereinafter sometimes referred to as substituted hydrocarbyl group) represents a monovalent group having a structure in which at least one hydrogen atom of a hydrocarbyl group is replaced with a substituent. A hydrocarbylene group having a hetero atom (hereinafter sometimes referred to as hetero atom-containing hydrocarbylene group) represents a divalent group having a structure in which a carbon atom other than the carbon atom from which a hydrogen atom has been removed, and/or a hydrogen atom, of a hydrocarbylene group, is replaced with a group having a hetero atom (an atom other than a carbon atom and a hydrogen atom).

### [Method for Producing Conjugated Diene-Based Polymer]

### <Compound Represented by Formula (1)>

In the method for producing a conjugated diene-based polymer of the present invention, a compound represented by the following formula (1) is used.

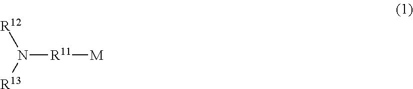

in formula (1), R¹¹ represents a hydrocarbylene group having 6 to 100 carbon atoms, R¹² and R¹³ each represent a hydrocarbyl group that optionally has a substituent or a trihydrocarbylsilyl group, or R¹² is bonded to R¹³ and the group in which R¹² is bonded to R¹³ represents a hydrocarbylene group optionally having a nitrogen atom and/or an oxygen atom as a hetero atom, a group having 5 to 20 carbon atoms represented by —Si(R¹⁴)₂—(CH₂)ₓ—Si(R¹⁴)₂— (R¹⁴ represents a hydrocarbyl group, and x represents an integer of 1 to 10), a group having 4 to 20 carbon atoms represented by —Si(R¹⁵)₂—(CH₂)_{y}— (R¹⁵ represents a hydrocarbyl group, and y represents an integer of 2 to 11), and M represents an alkali metal atom.

In formula (1), R¹¹ is a hydrocarbylene group having 6 to 100 carbon atoms, preferably a hydrocarbylene group having 7 to 90 carbon atoms preferably, more preferably a hydrocarbylene group having 8 to 80 carbon atoms. When the number of the carbon atoms of the hydrocarbylene group represented by R¹¹ is five or less, the solubility of the compound represented by formula (1) in a hydrocarbon solvent may lower.

When the number of the carbon atoms of the hydrocarbylene group represented by R¹¹ is 100 or more, the molecular weight of the compound represented by formula (1) is so large that the economical efficiency and the operativity in the polymerization may deteriorate.

In formula (1), the hydrocarbylene group represented by R¹¹ is preferably a group represented by the following formula (1-A),

CH₂ₗR¹⁶— (1-A)

in formula (1-A), R¹⁶ represents a hydrocarbylene group comprised of a structural unit derived from a conjugated diene compound and/or a structural unit derived from an aromatic vinyl compound, and l represents an integer of 1 to 10; (CH₂)ₗ is bonded to the nitrogen atom of formula (1).

In formula (1-A), R¹⁶ represents a hydrocarbylene group composed of a structural unit derived from a conjugated diene compound and/or a structural unit derived from an aromatic vinyl compound, and preferably is a hydrocarbylene group composed of a structural unit derived from isoprene.

The number of the structural units derived from the conjugated diene compound and/or the structural units derived from the aromatic vinyl compound in R¹⁶ is preferably 1 to 10, more preferably 1 to 5.

In formula (1-A), l is an integer of 1 to 10, preferably an integer of 2 to 4, and more preferably 3.

Examples of the group represented by formula (1-A) include a group in which 1 to 10 structural units derived from isoprene are combined with a methylene group, a group in which 1 to 10 structural units derived from isoprene are combined with an ethylene group, and a group in which 1 to 10 structural units derived from isoprene are combined with a trimethylene group.

R¹² and R¹³ in formula (1) each represent a hydrocarbyl group that optionally has a substituent or a trihydrocarbylsilyl group, or R¹² is bonded to R¹³ and the group in which R¹² is bonded to R¹³ represents a hydrocarbylene group optionally having a nitrogen atom and/or an oxygen atom as a hetero atom, a group having 5 to 20 carbon atoms represented by —Si(R¹⁴)₂—(CH₂)ₓ—Si(R¹⁴)₂— (R¹⁴ represents a hydrocarbyl group, and x represents an integer of 1 to 10), a group having 4 to 20 carbon atoms represented by —Si(R¹⁵)₂—(CH₂)— (R¹⁵ represents a hydrocarbyl group, and y represents an integer of 2 to 11).

The hydrocarbyl group optionally having a substituent of R¹² and R¹³ is a hydrocarbyl group or a substituted hydrocarbyl group. Examples of the substituent in the substituted hydrocarbyl group include a substituted amino group or a hydrocarbyloxy group. Examples of the hydrocarbyl group include chain alkyl groups such as a methyl group, an ethyl group, a n-propyl group, an isopropyl group, a n-butyl group, an isobutyl group, a sec-butyl group, a tert-butyl group, a n-pentyl group, a n-hexyl group, a n-octyl group, and a n-dodecyl group; cyclic alkyl groups such as a cyclopentyl group and a cyclohexyl group; and aryl groups such as a phenyl group and a benzyl group, and preferably chain alkyl groups, and more preferably chain alkyl groups having 1 to 4 carbon atoms. Examples of the substituted hydrocarbyl group whose substituent is a substituted amino group include a N,N-dimethylaminomethyl group, a 2-N,N-dimethylaminoethyl group, and a 3-N,N-dimethylaminopropyl group. Examples of the substituted hydrocarbyl group whose substituent is a hydrocarbyloxy group include a methoxymethyl group, a methoxyethyl group, and an ethoxymethyl group. Of these, a hydrocarbyl group is preferred, a chain alkyl group having 1 to 4 carbon atoms is more preferred, and a methyl group or an ethyl group is even more preferred.

Examples of the trihydrocarbylsilyl groups of R¹² and R¹³ include a trimethylsilyl group, and a tert-butyl-dimethylsilyl group, and a trimethylsilyl group is preferred.

The hydrocarbylene group optionally having a nitrogen atom and/or an oxygen atom as a hetero atom in the group in which R¹² is bonded to R¹³ is a hydrocarbylene group, or a hetero atom-containing hydrocarbylene group whose hetero atom is a nitrogen atom and/or an oxygen atom. Examples of the hetero atom-containing hydrocarbylene group whose hetero atom is a nitrogen atom and/or an oxygen atom include a hetero atom-containing hydrocarbylene group whose hetero atom is a nitrogen atom, and a hetero atom-containing hydrocarbylene group whose hetero atom is an oxygen atom.

Examples of the hydrocarbylene group include an alkylene group such as a tetramethylene group, a pentamethylene group, a hexamethylene group, and a 2,2,4-trimethylhexane-1,6-diyl group; and alkenediyl group such as a pentan-2-ene-1,5-diyl group, an alkylene group is preferred, and an alkylene group having 4 to 7 carbon atoms is more preferred. Examples of the hetero atom-containing hydrocarbylene group whose hetero atom is a nitrogen atom include a group represented by —CH═N—CH═CH— and a group represented by —CH═N—CH₂—CH₂—. Examples of the hetero atom-containing hydrocarbylene group whose hetero atom is an oxygen atom include a group represented by —CH₂—CH₂—O—CH₂—CH₂—. Among them, a hydrocarbylene group is preferable, an alkylene group having 4 to 7 carbon atoms is more preferable, and a tetramethylene group, a pentamethylene group, and a hexamethylene group are further preferable.

In the group in which R¹² is bonded to R¹³, examples of the group having 5 to 20 carbon atoms and represented by —Si(R¹⁴)₂—(CH₂)ₓ—Si(R¹⁴)₂— (R¹⁴ represents a hydrocarbyl group and x represents an integer of 1 to 10) include a group represented by —Si(CH₃)₂—CH₂—CH₂—Si(CH₃)₂—. Examples of the group having 4 to 20 carbon atoms and represented by —Si(R¹⁵)₂—(CH₂)_{y}— (R¹⁵ represents a hydrocarbyl group and y represents an integer of 2 to 11) include a group represented by —Si (CH₃)₂—CH₂—CH₂—CH₂—.

Preferably, R¹² and R¹³ are each a hydrocarbyl group, or R¹² is bonded to R¹³ and the group in which R¹² is bonded to R¹³ is a hydrocarbylene group; more preferably, R¹² and R¹³ are each a chain alkyl group having 1 to 4 carbon atoms, or R¹² is bonded to R¹³ and the group in which R¹² is bonded to R¹³ is an alkylene group having 4 to 7 carbon atoms; even more preferably, R¹² and R¹³ are each a chain alkyl group having 1 to 4 carbon atoms; and particularly preferably, R¹² and R¹³ are each a methyl group or an ethyl group.

In formula (1), M represents an alkali metal atom. Examples of the alkali metal atom include Li, Na, K and Cs, and Li is preferred.

Among the compounds represented by formula (1), examples of the compound wherein R¹¹ is a group represented by formula (1-A), R¹² and R¹³ are each a hydrocarbyl group, and M is Li include a compound obtained by reacting 1 mol to 5 mol (per 1 mol of a (dialkylamino)alkyllithium compound) of isoprene with the (dialkylamino)alkyllithium compound.

Examples of the (dialkylamino)alkyllithium compound include 3-(dimethylamino)propyllithium, 3-(diethylamino)propyllithium, 3-(dibutylamino)propyllithium, 4-(dimethylamino)butyllithium, 4-(diethylamino)butyllithium, 4-(dipropylamino)butyllithium, and 3-(dibutylamino)butyllithium.

Among the compounds represented by formula (1), examples of the compound wherein R¹¹ is a group represented by formula (1-A), R¹² is bonded to R¹³ and the group in which R¹² is bonded to R¹³ is a hydrocarbylene group, and M is Li include a compound obtained by reacting 1 mol to 5 mol (per 1 mol of a (hetero atom-free cyclic amino)alkyllithium compound)) of isoprene with the (hetero atom-free cyclic amino)alkyllithium compound.

Examples of the (hetero atom-free cyclic amino)alkyllithium compound include 3-(1-pyrrolidinyl)propyllithium, 3-(1-piperidinyl)propyllithium, 3-(1-hexamethyleneimino)propyllithium, and 3-[1-(1,2,3,6-tetrahydropyridinyl)]propyllithium.

Among the compounds represented by formula (1), examples of the compound wherein R¹¹ is a group represented by formula (1-A), R¹² is bonded to R¹³ and the group in which R¹² is bonded to R¹³ is a hetero atom-containing hydrocarbylene group, and M is Li include a compound obtained by reacting 1 mol to 5 mol (per 1 mol of a (hetero atom-containing cyclic amino)alkyllithium compound)) of isoprene with the (hetero atom-containing cyclic amino)alkyllithium compound.

Examples of the (hetero atom-containing cyclic amino)alkyllithium compound include 3-(1-morpholino)propyllithium, 3-(1-imidazolyl)propyllithium, and 3-(4,5-dihydro-1-imidazolyl)propyllithium.

Among the compounds represented by formula (1), examples of the compound wherein R¹¹ is a group represented by formula (1-A), R¹² is bonded to R¹³ and the group in which R¹² is bonded to R¹³ is a group having 5 to 20 carbon atoms represented by —Si(R¹⁴)₂—(CH₂)ₓ—Si(R¹⁴)₂— (R¹⁴ represents a hydrocarbyl group, and x represents an integer of 1 to 10), and M is Li include a compound obtained by reacting 1 mol to 5 mol (per 1 mol of 3-(2,2,5,5-tetramethyl-1-aza-2,5-disila-1-cyclopentyl)propyllithium) of isoprene with 3-(2,2,5,5-tetramethyl-1-aza-2,5-disila-1-cyclopentyl)propyllithium.

Among the compounds represented by formula (1), examples of the compound wherein R¹¹ is a group represented by formula (1-A), R¹² is bonded to R¹³ and the group in which R¹² is bonded to R¹³ is a group having 4 to 20 carbon atoms and represented by —Si(R¹⁵)₂—(CH₂)_{y}— (R¹⁵ represents a hydrocarbyl group and y represents an integer of 2 to 11), and M is Li include a compound obtained by reacting 1 mol to 5 mol (per 1 mol of 3-(2,2-dimethyl-1-aza-2-sila-1-cyclopentyl)propyllithium) of isoprene with 3-(2,2-dimethyl-1-aza-2-sila-1-cyclopentyl)propyllithium.

The compound represented by formula (1) is preferably a compound wherein R¹¹ is a group represented by formula (1-A), R¹² and R¹³ are each a hydrocarbyl group, and M is Li, more preferably a compound wherein R¹² and R¹³ are each an alkyl group having 1 to 4 carbon atoms, M is Li, R¹¹ is represented by formula (1-A), R¹⁶ is a group composed of 1 to 5 structural units derived from isoprene, and 1 is 2 to 4, and even more preferably a compound obtained by reacting 1 mol to 5 mol (per 1 mol of 3-(dimethylamino)propyllithium or 3-(diethylamino)propyllithium) of isoprene to 3-(dimethylamino)propyllithium or 3-(diethylamino)propyllithium.

The compound represented by formula (1) may be a mixture of a plurality of compounds differing in R¹¹.

### <Monomer>

The first one of the compounds included in the monomers to be polymerized in the method for producing a conjugated diene-based polymer of the present invention is a compound represented by the following formula (2),

E²-A² (2)

in formula (2), E² represents a hydrocarbyl group having a polymerizable carbon-carbon double bond, and A² represents a substituted amino group or a nitrogen-containing heterocyclic group.

E² in formula (2) represents a hydrocarbyl group having a polymerizable carbon-carbon double bond, and A² represents a substituted amino group or a nitrogen-containing heterocyclic group.

E² is preferably a group represented by the following formula (2-E).

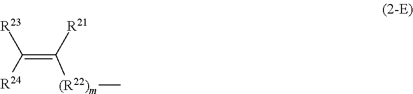

in formula (2-E), m represents an integer of 0 or 1, R²¹, R²³ and R²⁴ are each a hydrogen atom or a hydrocarbyl group, and R²² represents a hydrocarbylene group.

In formula (2-E), m represents an integer of 0 or 1.

Examples of the hydrocarbyl groups of R²¹, R²³ and R²⁴ include an alkyl group, an alkenyl group, and an aryl group. Examples of the alkyl group include a methyl group, an ethyl group, a n-propyl group, an isopropyl group, a n-butyl group, a sec-butyl group, and a tert-butyl group, and preferred is a methyl group. Examples of the alkenyl group include a vinyl group, an allyl group, a 1-propenyl group, and an isopropenyl group, and preferred is a vinyl group. Examples of the aryl group include a phenyl group, a methylphenyl group, and an ethylphenyl group, and preferred is a phenyl group.

Preferred as R²¹ is a hydrogen atom, a methyl group, a vinyl group, or a phenyl group, and more preferred is a hydrogen atom.

Preferred as R²³ and R²⁴ is a hydrogen atom.

Examples of the hydrocarbylene group of R²² include an alkylene group, an arylene group, and a group in which an arylene group is bonded to an alkylene group.

Examples of the alkylene group include a methylene group, an ethylene group, and a trimethylene group. Preferred is a methyl group or an ethyl group. Examples of the arylene group include a phenylene group, a naphthylene group, and a biphenylene group. Preferred is a phenylene group. More preferred is a para-phenylene group or a meta-phenylene group.

Examples of the group in which an arylene group is bonded to an alkylene group include a group in which a phenylene group is bonded to an alkylene group, a group in which a naphthylene group is bonded to an alkylene group, and a group in which a biphenylene group is bonded to an alkylene group. Preferred is a group in which a phenylene group is bonded to an alkylene group.

As to the group in which an arylene group is bonded to an alkylene group, a carbon atom of the arylene group is preferably attached to the carbon atom to which R²¹ of formula (2-V) is attached.

Examples of the group in which a phenylene group is bonded to an alkylene group (hereinafter sometimes referred to a phenylene-alkylene group) include a group represented by the following formula (2-R),

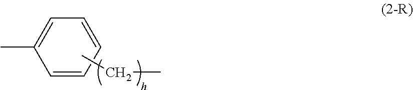

wherein h represents an integer of 1 to 10, and (CH₂)ₕ is a substituent on the benzene ring.

Examples of the phenylene-alkylene group include, depending upon the position of the benzene ring carbon atom to which the alkylene group is attached, a para-phenylene-alkylene group, a meta-phenylene-alkylene group, and an ortho-phenylene-alkylene group. In the case of a group represented by formula (2-R), the para-phenylene-alkylene group is a group represented by the following formula (2-Ra), the meta-phenylene-alkylene group is a group represented by the following (2-Rb), and the ortho-phenylene-alkylene group is a group represented by the following formula (2-Rc),

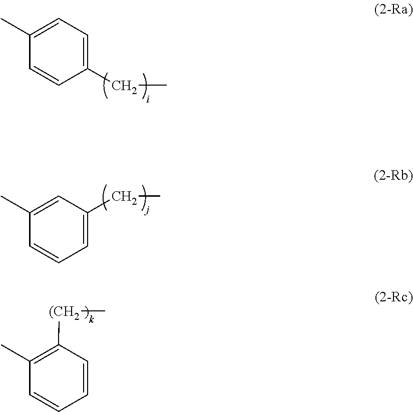

wherein i, j, and k each represent an integer of 1 to 10.

h in formula (2-R), i in formula (2-Ra), j in formula (2-Rb), and k in formula (2-Rc) are preferably 1 to 5, more preferably 1 or 2, and even more preferably 2.

Preferred as the group in which an arylene group is bonded to an alkylene group is a group in which a phenylene group is bonded to an alkylene group, more preferred is a group represented by the above formula (2-Ra) or a group represented by the above formula (2-Rb), even more preferred is a para-phenylene-methylene group (a group represented by formula (2-Ra) wherein i=1), a meta-phenylene-methylene group (a group represented by formula (2-Rb) wherein j=1), a para-phenylene-ethylene group (a group represented by formula (2-Ra) wherein i=2), or a meta-phenylene-ethylene group (a group represented by formula (2-Rb) wherein j=2), and particularly preferred is a para-phenylene-ethylene group (a group represented by formula (2-Ra) wherein i=2), or a meta-phenylene-ethylene group (a group represented by a formula (2-Rb) wherein j=2).

Examples of the group represented formula (2-E) include the groups shown below.

Examples of the group wherein R²¹, R²³ and R²⁴ are hydrogen atoms include a vinyl group, an allyl group, a 3-butenyl group, a 4-vinylphenyl group, a 3-vinylphenyl group, a (4-vinylphenyl)methyl group, a 2-(4-vinylphenyl)ethyl group, a (3-vinylphenyl)methyl group, and a 2-(3-vinylphenyl)ethyl group.

Examples of the group wherein R²¹ is a methyl group and R²³ and R²⁴ are hydrogen atoms include an isopropenyl group, a 2-methyl-2-propenyl group, a 4-isopropenylphenyl group, a 3-isopropenylphenyl group, a (4-isopropenylphenyl)methyl group, a 2-(4-isopropenylphenyl)ethyl group, a (3-isopropenylphenyl)methyl group, and a 2-(3-isopropenylphenyl)ethyl group.

Examples of the group in which R²¹ is a vinyl group and R²³ and R²⁴ are hydrogen atoms include a 1-methylene-2-propenyl group and a 2-methylene-3-butenyl group.

Examples of the group in which R²¹ is a phenyl group and R²³ and R²⁴ are hydrogen atoms include a 1-phenylethenyl group, a 2-phenyl-2-propenyl group, a 4-(1-phenylethenyl)phenyl group, a 3-(1-phenylethenyl)phenyl group, and a 2-(1-phenylethenyl)phenyl group.

Examples of the group in which R²¹ is a hydrogen atom, R²³ is a methyl group, and R²⁴ is a hydrogen atom include a 1-propenyl group, a 2-butenyl group, a 4-(1-propenyl)phenyl group, a [4-(1-propenyl)phenyl]methyl group, a 2-[4-(1-propenyl)phenyl]ethyl group, a 3-(1-propenyl)phenyl group, a [3-(1-propenyl)phenyl]methyl group, and a 2-[3-(1-propenyl)phenyl]ethyl group.

The group represented by formula (2-E) is preferably a group represented by the following formula (2-E1),

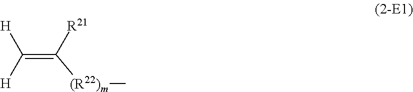

wherein R²¹ represents a hydrogen atom or a hydrocarbyl group, m represents an integer of 0 or 1, and R²² represents a hydrocarbylene group.

Among preferable groups represented by formula (2-E1), examples of the group wherein R²¹ is a hydrogen atom include a vinyl group, a 4-vinylphenyl group, a 3-vinylphenyl group, a (4-vinylphenyl)methyl group, a 2-(4-vinylphenyl)ethyl group, a (3-vinylphenyl)methyl group, and 2-(3-vinylphenyl)ethyl group. Examples of the group wherein R²¹ is a methyl group include a 4-isopropenylphenyl group, a 3-isopropenylphenyl group, a (4-isopropenylphenyl)methyl group, a 2-(4-isopropenylphenyl)ethyl group, a (3-isopropenylphenyl)methyl group, and a 2-(3-isopropenylphenyl)ethyl group. Examples of the group wherein R²¹ is a vinyl group include a 1-methylene-2-propenyl group and a 2-methylene-3-butenyl group. Examples of the group wherein R²¹ is a phenyl group include a 4-(1-phenylethenyl)phenyl group.

A group wherein R²¹ is a hydrogen atom is more preferred as the group represented by formula (2-E1), and a group wherein m=1 and R²² is a group represented by formula (2-R), a vinylphenyl group, or a vinyl group is even more preferred.

In formula (2), A² represents a substituted amino group or a nitrogen-containing heterocyclic group.

Preferred as the substituted amino group of A² is a group represented by the following formula (2-A),

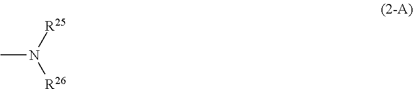

wherein R²⁵ and R²⁶ are each a hydrocarbyl group or a trihydrocarbylsilyl group, or R²⁵ is bonded to R²⁶ and the group in which R²⁵ is bonded to R²⁶ represents a hydrocarbylene group optionally having a nitrogen atom and/or an oxygen atom as a hetero atom, or R²⁵ and R²⁶ represent together one group that is bonded to the nitrogen atom via a double bond.

Examples of the hydrocarbyl groups of R²⁵ and R²⁶ include an alkyl group, an alkenyl group, an alkynyl group, an aryl group, and an aralkyl group. Examples of the alkyl group include a methyl group, an ethyl group, a n-propyl group, an isopropyl group, a n-butyl group, a sec-butyl group, and a tert-butyl group. Examples of the alkenyl group include a vinyl group, an allyl group, a 1-propenyl group, and an isopropenyl group. Examples of the alkynyl group include an ethynyl group and a 2-propynyl group. Examples of the aryl group include a phenyl group, a tolyl group, and a xylyl group. Examples of the aralkyl group include a benzyl group.

The number of the carbon atoms of each of the hydrocarbyl groups of R²⁵ and R²⁶ is preferably 1 to 10, more preferably 1 to 4, even more preferably 1 to 2.

The hydrocarbyl groups of R²⁵ and R²⁶ are each preferably an alkyl group or an alkenyl group, more preferably an alkyl group, and even more preferably a linear alkyl group.

Examples of the trihydrocarbylsilyl groups of R²⁵ and R²⁶ include trialkylsilyl groups such as a trimethylsilyl group, a triethylsilyl group, a triisopropylsilyl group, and a tert-butyl-dimethylsilyl group.

The trihydrocarbylsilyl groups of R²⁵ and R²⁶ are each preferably a trialkylsilyl group having 3 to 9 carbon atoms, more preferably a trialkylsilyl group in which the alkyl group attached to the silicon atom is an alkyl group having 1 to 4 carbon atoms, and even more preferably a trimethylsilyl group.

In the group in which R²⁵ is bonded to R²⁶, examples of the hydrocarbylene group optionally having a nitrogen atom and/or an oxygen atom as a hetero atom include a hydrocarbylene group, a hetero atom-containing hydrocarbylene group having a nitrogen atom as the hetero atom, and a hetero atom-containing hydrocarbylene group having an oxygen atom as the hetero atom. Examples of the hydrocarbylene group include alkylene groups such as an ethylene group, a trimethylene group, a tetramethylene group, a pentamethylene group, and a hexamethylene group, and a 1,3-butadiene-1,4-diyl group. Examples of the hetero atom-containing hydrocarbylene group having a nitrogen atom as the hetero atom include a group represented by —CH₂CH₂—NH—CH₂—, a group represented by —CH₂CH₂—N═CH—, a group represented by —CH═CH—N═CH—, and a group represented by —CH₂CH₂—NH—CH₂CH₂—. Examples of the hetero atom-containing hydrocarbylene group having an oxygen atom as the hetero atom include a group represented by —CH₂CH₂—O—CH₂CH₂—.

The number of the carbon atoms of the group in which R²⁵ is bonded to R²⁶ is preferably 2 to 20, more preferably 3 to 8, and even more preferably 4 to 6.

In the group in which R²⁵ is bonded to R²⁶, the hydrocarbylene group optionally having a nitrogen atom and/or an oxygen atom as a hetero atom is preferably a hydrocarbylene group, more preferably an alkane group, even more preferably a polymethylene group.

Examples of the group in which R²⁵ and R²⁶ are bonded to the nitrogen atom via a double bond include hydrocarbylidene groups such as an ethylidene group, a propylidene group, a butylidene group, a 1-methylethylidene group, a 1-methylpropylidene group, and a 1,3-dimethylbutylidene group.

The numbers of the carbon atoms of the group in which R²⁵ and R²⁶ are bonded to the nitrogen atom via a double bond is preferably 2 to 20, more preferably 2 to 6.

Preferably, R²⁵ and R²⁶ are each a hydrocarbyl group or a trihydrocarbylsilyl group, or alternatively R²⁵ is bonded to R²⁶ and the group in which R²⁵ is bonded to R²⁶ is a hydrocarbylene group.

Examples of the group represented by formula (2-A) include an acyclic amino group and a cyclic amino group.

Among acyclic amino groups, examples of the group of formula (2-A) wherein R²⁵ and R²⁶ are each a hydrocarbyl group include dialkylamino groups such as a dimethylamino group, a diethylamino group, a di(n-propyl)amino group, a di(isopropyl)amino group, a di(n-butyl)amino group, a di(sec-butyl)amino group, a di(tert-butyl)amino group, and an ethylmethylamino group. Among acyclic amino groups, examples of the group of formula (2-A) wherein R²⁵ and R²⁶ are each a trihydrocarbylsilyl group include bis(trialkylsilyl)amino groups such as a bis(trimethylsilyl)amino group and a bis(tert-butyl-dimethylsilyl)amino group.

Among acyclic amino groups, examples of the group of formula (2-A) in which R²⁵ and R²⁶ represent together one group that is bonded to the nitrogen atom via a double bond include an ethylideneamino group, a 1-methylpropylideneamino group, a 1,3-dimethylbutylideneamino group, a 1-methylethylideneamino group, and a 4-N,N-dimethylaminobenzylideneamino group.

Among such cyclic amino groups, examples of a group of formula (2-A) wherein R²⁵ is bonded to R²⁶ and the group in which R²⁵ is bonded to R²⁶ is a hydrocarbylene group include a 1-aziridinyl group, a 1-azetidinyl group, a 1-pyrrolidinyl group, a 1-piperidinyl group, a 1-hexamethyleneimino group, and a 1-pyrrolyl group.

Among cyclic amino groups, examples of a group of formula (2-A) wherein R²⁵ is bonded to R²⁶ and the group in which R²⁵ is bonded to R²⁶ is a hydrocarbylene group including a nitrogen atom as a hetero atom include a 1-imidazolyl group, a 4,5-dihydro-1-imidazolyl group, a 1-imidazolidinyl group, and a 1-piperazinyl group.

Among cyclic amino groups, examples of a group of formula (2-A) wherein R²⁵ is bonded to R²⁶ and the group in which R²⁵ is bonded to R²⁶ is a hydrocarbylene group containing an oxygen atom as a hetero atom include a morpholino group.

The group represented by formula (2-A) is preferably a group wherein R²⁵ and R²⁶ are each a hydrocarbyl group, a group wherein R²⁵ and R²⁶ are each a trihydrocarbylsilyl group, or a group wherein R²⁵ is bonded to R²⁶ and the group in which R²⁵ is bonded to R²⁶ is a hydrocarbylene group. More preferred is a group wherein R²⁵ and R²⁶ are each a linear alkyl group, a group wherein R²⁵ and R²⁶ are each a trialkylsilyl group, or a group wherein the group in which R²⁵ is bonded to R²⁶ is a polymethylene group.

A more preferred group as the group represented by formula (2-A) wherein R²⁵ and R²⁶ are each a linear alkyl group is a dimethylamino group, a diethylamino group, a di(n-propyl)amino group, or a di(n-butyl)amino group, a more preferred group wherein R²⁵ and R²⁶ are each a trialkylsilyl group is a bis(trimethylsilyl)amino group or a bis(tert-butyl-dimethylsilyl)amino group, and a more preferred group wherein the group in which R²⁵ is bonded to R²⁶ is a polymethylene group is a 1-pyrrolidinyl group, a 1-piperidinyl group, or 1-hexamethyleneimino group.

Examples of the nitrogen-containing heterocyclic group of A² include a nitrogen-containing heteroalicyclic group and a nitrogen-containing aromatic heterocyclic group. In this specification, the nitrogen-containing heteroalicyclic group represents a group formed by removing one of the hydrogen atoms bonded to the carbon atoms of the heterocyclic ring of a compound having a nitrogen-containing alicyclic heterocyclic ring, and the nitrogen-containing alicyclic heterocyclic ring represents an alicyclic heterocyclic ring containing a nitrogen atom as a hetero atom included in the atoms constituting the ring. In addition, the nitrogen-containing aromatic heterocyclic group represents a group formed by removing one of the hydrogen atoms bonded to the carbon atoms of the heterocyclic ring of a compound having a nitrogen-containing aromatic heterocyclic ring, and the nitrogen-containing aromatic heterocyclic ring represents an aromatic heterocyclic ring containing a nitrogen atom as a hetero atom included in the atoms constituting the ring.

Examples of the nitrogen-containing heteroalicyclic group of A² include a group having only a nitrogen atom as a hetero atom included in the atoms constituting the ring, a group having a nitrogen atom and an oxygen atom as hetero atoms included in the atoms constituting the ring, and a group having a nitrogen atom and a sulfur atom as hetero atoms included in the atoms constituting the ring.

Examples of the nitrogen-containing heteroalicyclic group containing only a nitrogen atom as a hetero atom included in the atoms constituting the ring include a group having an aziridine ring, a group having an azetidine ring, a group having a pyrrolidine ring, a group having a piperidine ring, a group having a hexamethyleneimine ring, a group having an imidazolidine ring, a group having a piperazine ring, and a group having a pyrazolidine ring.

Examples of the group having an aziridine ring include a 1-alkyl-2-aziridinyl group.

Examples of the group having an azetidine ring include a 1-alkyl-2-azetidinyl group and a 1-alkyl-3-azetidinyl group.

Examples of the group having a pyrrolidine ring include a 1-alkyl-2-pyrrolidinyl group and a 1-alkyl-3-pyrrolidinyl group.

Examples of the group having a piperidine ring include a 1-alkyl-2-piperidinyl group, a 1-alkyl-3-piperidinyl group, and a 1-alkyl-4-piperidinyl group.

Examples of the group having a hexamethyleneimine ring include a 1-alkyl-2-hexamethyleneimino group, a 1-alkyl-3-hexamethyleneimino group, and a 1-alkyl-4-hexamethyleneimino group.

Examples of the group having an imidazolidine ring include a 1,3-dialkyl-2-imidazolidyl group and a 1,3-dialkyl-4-imidazolidyl group.

Examples of the group having a piperazine ring include a 1,4-dialkyl-2-piperazinyl group.

Examples of the group having a pyrazolidine ring include a 1,2-dialkyl-3-pyrazolidyl group and 1,2-dialkyl-4-pyrazolidyl group.

Examples of the nitrogen-containing heteroalicyclic group having a nitrogen atom and an oxygen atom as hetero atoms included in the atoms constituting the ring include a group having a morpholine ring and a group having an isooxazolidine ring.

Examples of the group having a morpholine ring include a 4-alkyl-2-morpholino group and a 4-alkyl-3-morpholino group.

Examples of the group having an isooxazolidine ring include a 2-alkyl-3-isooxazolidinyl group, a 2-alkyl-4-isooxazolidinyl group, and a 2-alkyl-5-isooxazolidinyl group.

Examples of the nitrogen-containing heteroalicyclic group having a nitrogen atom and a sulfur atom as hetero atoms included in the atoms constituting the ring include a group having a thiomorpholine ring and a group having an isothiazolidine ring.

Examples of the group having a thiomorpholine ring include a 4-alkyl-2-thiomorpholino group and a 4-alkyl-3-thiomorpholino group.

Examples of the group having an isothiazolidine ring include a 2-alkyl-3-isothiazolydinyl group, a 2-alkyl-4-isothiazolydinyl group, and a 2-alkyl-5-isothiazolydinyl group.

Preferred as the nitrogen-containing heteroalicyclic group of A² is a group having only a nitrogen atom as a hetero atom constituting a ring. The number of the carbon atoms of the nitrogen-containing heteroalicyclic group is preferably 4 to 10.

Examples of the nitrogen-containing aromatic heterocyclic group of A² include a group having only a nitrogen atom as a hetero atom included in the atoms constituting the ring, a group having a nitrogen atom and an oxygen atom as hetero atoms included in the atoms constituting the ring, and a group having a nitrogen atom and a sulfur atom as hetero atoms included in the atoms constituting the ring.

Examples of the nitrogen-containing aromatic heterocyclic group having only a nitrogen atom as a hetero atom included in the atoms constituting the ring include a group having a pyrrole ring, a group having an imidazole ring, a group having a pyrazole ring, a group having a pyridine ring, a group having a pyridazine ring, a group having a pyrimidine ring, a group having a pyrazine ring, a group having a quinoline ring, a group having an isoquinoline ring, a group having a cinnoline ring, a group having a quinazoline ring, and a group having a phthalazine ring.

Examples of the group having a pyrrole ring include a 2-pyrrolyl group, a 3-pyrrolyl group, a 1-alkyl-2-pyrrolyl group, and a 1-alkyl-3-pyrrolyl group.

Examples of the group having an imidazole ring include a 2-imidazolyl group, a 4-imidazolyl group, a 5-imidazolyl group, a 1-alkyl-2-imidazolyl group, a 1-alkyl-4-imidazolyl group, and a 1-alkyl-5-imidazolyl group.

Examples of the group having a pyrazole ring include a 3-pyrazolyl group, a 4-pyrazolyl group, a 5-pyrazolyl group, a 1-alkyl-3-pyrazolyl group, a 1-alkyl-4-pyrazolyl group, and a 1-alkyl-5-pyrazolyl group.

Examples of the group having a pyridine ring include a 2-pyridyl group, a 3-pyridyl group, and a 4-pyridyl group.

Examples of the group having a pyridazine ring include a 3-pyridazyl group and a 4-pyridazyl group.

Examples of the group having a pyrimidine ring include a 2-pyrimidyl group, a 4-pyrimidyl group, and a 5-pyrimidyl group.

Examples of the group having a pyrazine ring include a 2-pyrazyl group.

Examples of the group having a quinoline ring include a 2-quinolyl group, a 3-quinolyl group, a 4-quinolyl group, a 5-quinolyl group, a 6-quinolyl group, a 7-quinolyl group, and an 8-quinolyl group.

Examples of the group having an isoquinoline ring include a 1-isoquinolyl group, a 3-isoquinolyl group, a 4-isoquinolyl group, a 5-isoquinolyl group, a 6-isoquinolyl group, a 7-isoquinolyl group, and an 8-isoquinolyl group.

Examples of the group having a cinnoline ring include a 3-cinnolinyl group, a 4-cinnolinyl group, a 5-cinnolinyl group, a 6-cinnolinyl group, a 7-cinnolinyl group, and an 8-cinnolinyl group.

Examples of the group having a quinazoline ring include a 2-quinazolinyl group, a 4-quinazolinyl group, a 5-quinazolinyl group, a 6-quinazolinyl group, a 7-quinazolinyl group, and an 8-quinazolinyl group.

Examples of the group having a phthalazine ring include a 1-phthalazinyl group, a 5-phthalazinyl group, and a 6-phthalazinyl group.

Preferred as the nitrogen-containing aromatic heterocyclic group having only a nitrogen atom as a hetero atom included in the atoms constituting the ring are a group having an imidazole ring, a group having a pyridine ring, and a group having a quinoline ring.

Examples of the nitrogen-containing aromatic heterocyclic group having a nitrogen atom and an oxygen atom as hetero atom included in the atoms constituting the ring include a group having an oxazole ring and a group having an isooxazole ring.

Examples of the group having an oxazole ring include a 2-oxazolyl group, a 4-oxazolyl group, and a 5-oxazolyl group.

Examples of the group having an isooxazole ring include a 3-isoxazolyl group, a 4-isoxazolyl group, and a 5-isoxazolyl group.

Preferred as the nitrogen-containing aromatic heterocyclic group having a nitrogen atom and an oxygen atom as hetero atom included in the atoms constituting the ring is a group having an oxazole ring.

Examples of the nitrogen-containing aromatic heterocyclic group having a nitrogen atom and a sulfur atom as hetero atom included in the atoms constituting the ring include a group having a thiazole ring and a group having an isothiazole ring.

Examples of the group having a thiazole ring include a 2-thiazolyl group, a 4-thiazolyl group, and a 5-thiazolyl group.

Examples of the group having an isothiazole ring include a 3-isothiazolyl group, a 4-isothiazolyl group, and a 5-isothiazolyl group.

Preferred as the nitrogen-containing aromatic heterocyclic group having a nitrogen atom and a sulfur atom as hetero atom included in the atoms constituting the ring is a group having a thiazole ring.

The nitrogen-containing aromatic heterocyclic group of A² is preferably a nitrogen-containing aromatic heterocyclic group having only a nitrogen atom as a hetero atom included in the atoms constituting the ring, more preferably a group having an imidazole ring, a group having a pyridine ring, or a group having a quinoline ring, and even more preferably a group having a pyridine ring.

The compound represented by formula (2) is preferably a group represented by the following formula (2-1) wherein E² is a group represented by formula (2-E1),

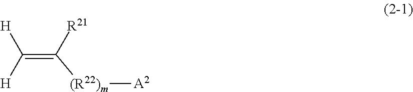

wherein R²¹ represents a hydrogen atom or a hydrocarbyl group, m represents an integer of 0 or 1, R²² represents a hydrocarbylene group, and A² represents a substituted amino group or a nitrogen-containing heterocyclic group.

Among the compounds represented by formula (2-1), examples of the compound wherein R²¹ is a hydrogen atom, m is 0, and A² is a substituted amino group include the following compounds:
1-vinylpyrrolidine,
1-vinylpiperidine,
1-vinylhexamethyleneimine,
1-vinylpiperazine,
1-vinylpyrrole,
1-vinylimidazole.

Among the compounds represented by formula (2-1), examples of the compound wherein R²¹ is a hydrogen atom, m is 1, R²² is a phenylene group, and A² is a substituted amino group include the following compounds:
4-dimethylaminostyrene,
4-diethylaminostyrene,
4-dipropylaminostyrene,
4-dibutylaminostyrene,
4-diallylaminostyrene,
4-bis(trimethylsilyl)aminostyrene,
4-bis(tert-butyl-dimethylsilyl)aminostyrene,
4-(1-aziridinyl)styrene,
4-(1-pyrrolidinyl)styrene,
4-(1-piperidinyl)styrene,
4-(1-hexamethyleneimino)styrene,
3-dimethylaminostyrene,
3-diethylaminostyrene,
3-dipropylaminostyrene,
3-dibutylaminostyrene,
3-diallylaminostyrene,
3-bis(trimethylsilyl)aminostyrene,
3-bis(tert-butyl-dimethylsilyl)aminostyrene,
3-(1-aziridinyl)styrene,
3-(1-pyrrolidinyl)styrene,
3-(1-piperidinyl)styrene,
3-(1-hexamethyleneimino)styrene.

Among the compounds represented by formula (2-1), examples of the compound wherein R²¹ is a hydrogen atom, m is 1, R²² is a group represented by formula (2-Ra), and A² is a substituted amino group include the following compounds:

Compounds of formula (2-Ra) wherein i is 1:
4-(dimethylaminomethyl)styrene,
4-(diethylaminomethyl)styrene,
4-(dipropylaminomethyl)styrene,
4-(dibutylaminomethylstyrene,
4-(diallylaminomethyl)styrene,
4-[bis(trimethylsilyl)aminomethyl]styrene,
4-[bis(tert-butyl-dimethylsilyl)aminomethyl]styrene,
4-(1-aziridinyl)methylstyrene,
4-(1-pyrrolidinyl)methylstyrene,
4-(1-piperidinyl)methylstyrene,
4-(1-hexamethyleneimino)methylstyrene.
   Compounds of formula (2-Ra) wherein i is 2:
4-[2-(dimethylamino)ethyl]styrene,
4-[2-(diethylamino)ethyl]styrene,
4-[2-(dipropylamino)ethyl]styrene,
4-[2-(dibutylamino)ethyl]styrene,
4-[2-(diallylamino)ethyl]styrene,
4-{2-[bis(trimethylsilyl)amino]ethyl}styrene,
4-{2-[bis(tert-butyl-dimethylsilyl)amino]ethyl}styrene,
4-[2-(1-aziridinyl)ethyl]styrene,
4-[2-(1-pyrrolidinyl)ethyl]styrene,
4-[2-(1-piperidinyl)ethyl]styrene,
4-[2-(1-hexamethyleneimino)ethyl]styrene.

Among the compounds represented by formula (2-1), examples of the compound wherein R²¹ is a hydrogen atom, m is 1, R²² is a group represented by formula (2-Rb), and A² is a substituted amino group include the following compounds:

Compounds of formula (2-Rb) wherein j is 1:
3-(dimethylaminomethyl)styrene,
3-(diethylaminomethyl)styrene,
3-(dipropylaminomethyl)styrene,
3-(dibutylaminomethylstyrene,
3-(diallylaminomethyl)styrene,
3-[bis(trimethylsilyl)aminomethyl]styrene,
3-[bis(tert-butyl-dimethylsilyl)aminomethyl]styrene,
3-(1-aziridinyl)methylstyrene,
3-(1-pyrrolidinyl)methylstyrene,
3-(1-piperidinyl)methylstyrene,
3-(1-hexamethyleneimino)methylstyrene.
   Compounds of formula (2-Rb) wherein j is 2:
3-[2-(dimethylamino)ethyl]styrene,
3-[2-(diethylamino)ethyl]styrene,
3-[2-(dipropylamino)ethyl]styrene,
3-[2-(dibutylamino)ethyl]styrene,
3-[2-(diallylamino)ethyl]styrene,
4-{2-[bis(trimethylsilyl)amino]ethyl}styrene,
3-{2-[bis(tert-butyl-dimethylsilyl)amino]ethyl}styrene,
3-[2-(1-aziridinyl)ethyl]styrene,
3-[2-(1-pyrrolidinyl)ethyl]styrene,
3-[2-(1-piperidinyl)ethyl]styrene,
3-[2-(1-hexamethyleneimino)ethyl]styrene.

Among the compounds represented by formula (2-1), examples of the compound wherein R²¹ is a methyl group, m is 0, and A² is a substituted amino group include the following compounds:
1-isopropenylpyrrolidine,
1-isopropenylpiperidine,
1-isopropenylhexamethyleneimine,
1-isopropenylpiperazine,
1-isopropenylpyrrole,
1-isopropenylimidazole.

Among the compounds represented by formula (2-1), examples of the compound wherein R²¹ is a methyl group, m is 1, R²² is a phenylene group, and A² is a substituted amino group include the following compounds:
4-dimethylamino-1-isopropenylbenzene,
4-diethylamino-1-isopropenylbenzene,
4-(dipropylamino)-1-isopropenylbenzene,
4-(dibutylamino)-1-isopropenylbenzene,
4-diallylamino-1-isopropenylbenzene,
4-bis(trimethylsilyl)amino-1-isopropenylbenzene,
4-bis(tert-butyl-dimethylsilyl)amino-1-isopropenylbenzene,
4-(1-aziridinyl)-1-isopropenylbenzene,
4-(1-pyrrolidinyl)-1-isopropenylbenzene,
4-(1-piperidinyl)-1-isopropenylbenzene,
4-(1-hexamethyleneimino)-1-isopropenylbenzene,
3-dimethylamino-1-isopropenylbenzene,
3-diethylamino-1-isopropenylbenzene,
3-dipropylamino-1-isopropenylbenzene,
3-dibutylamino-1-isopropenylbenzene,
3-diallylamino-1-isopropenylbenzene,
3-bis(trimethylsilyl)amino-1-isopropenylbenzene,
3-bis(tert-butyl-dimethylsilyl)amino-1-isopropenylbenzene,
3-(1-aziridinyl)-1-isopropenylbenzene,
3-(1-pyrrolidinyl)-1-isopropenylbenzene,
3-(1-piperidinyl)-1-isopropenylbenzene,
3-(1-hexamethyleneimino)-1-isopropenylbenzene,

Among the compounds represented by formula (2-1), examples of the compound wherein R²¹ is a methyl group, m is 1, R²² is a group represented by formula (2-Ra), and A² is a substituted amino group include the following compounds:

Compounds of formula (2-Ra) wherein i is 1:
4-dimethylaminomethyl-1-isopropenylbenzene,
4-diethylaminomethyl-1-isopropenylbenzene,
4-di-n-propylaminomethyl-1-isopropenylbenzene,
4-di-n-butylaminomethyl-1-isopropenylbenzene,
4-diallylaminomethyl-1-isopropenylbenzene,
4-bis(trimethylsilyl)aminomethyl-1-isopropenylbenzene,
4-bis(tert-butyl-dimethylsilyl)aminomethyl-1-isopropenylbenzene,
4-(1-aziridinyl)methyl-1-isopropenylbenzene,
4-(1-pyrrolidinyl)methyl-1-isopropenylbenzene,
4-(1-piperidinyl)methyl-1-isopropenylbenzene,
4-(1-hexamethyleneimino)methyl-1-isopropenylbenzene.
   Compounds of formula (2-Ra) wherein i is 2:
4-[2-(dimethylamino)ethyl]-1-isopropenylbenzene,
4-[2-(diethylamino)ethyl]-1-isopropenylbenzene,
4-[2-(dipropylamino)ethyl]-1-isopropenylbenzene,
4-[2-(dibutylamino)ethyl]-1-isopropenylbenzene,
4-[2-(diallylamino)ethyl]-1-isopropenylbenzene,
4-{2-[bis(trimethylsilyl)amino]ethyl}-1-isopropenylbenzene,
4-{2-[bis(tert-butyl-dimethylsilyl)amino]ethyl}-1-isopropenylbenzene,
4-[2-(1-aziridinyl)ethyl]-1-isopropenylbenzene,
4-[2-(1-pyrrolidinyl)ethyl]-1-isopropenylbenzene,
4-[2-(1-piperidinyl)ethyl]-1-isopropenylbenzene,
4-[2-(1-hexamethyleneimino)ethyl]-1-isopropenylbenzene.

Among the compounds represented by formula (2-1), examples of the compound wherein R²¹ is a methyl group, m is 1, R²² is a group represented by formula (2-Rb), and A² is a substituted amino group include the following compounds:

Compounds of formula (2-Rb) wherein j is 1:
3-dimethylaminomethyl-1-isopropenylbenzene,
3-diethylaminomethyl-1-isopropenylbenzene,
3-dipropylaminomethyl-1-isopropenylbenzene,
3-dibutylaminomethyl-1-isopropenylbenzene,
3-diallylaminomethyl-1-isopropenylbenzene,
3-bis(trimethylsilyl)aminomethyl-1-isopropenylbenzene,
3-bis(tert-butyl-dimethylsilyl)aminomethyl-1-isopropenylbenzene,
3-(1-aziridinyl)methyl-1-isopropenylbenzene,
3-(1-pyrrolidinyl)methyl-1-isopropenylbenzene,
3-(1-piperidinyl)methyl-1-isopropenylbenzene,
3-(1-hexamethyleneimino)methyl-1-isopropenylbenzene.
   Compounds of formula (2-Rb) wherein j is 2:
3-[2-(dimethylamino)ethyl]-1-isopropenylbenzene,
3-[2-(diethylamino)ethyl]-1-isopropenylbenzene,
3-[2-(dipropylamino)ethyl]-1-isopropenylbenzene,
3-[2-(di-n-butylamino)ethyl]-1-isopropenylbenzene,
3-[2-(diallylamino)ethyl]-1-isopropenylbenzene,
3-{2-[bis(trimethylsilyl)amino]ethyl}-1-isopropenylbenzene,
3-{2-[bis(tert-butyl-dimethylsilyl)amino]ethyl}-1-isopropenylbenzene,
3-[2-(1-aziridinyl)ethyl]-1-isopropenylbenzene,
3-[2-(1-pyrrolidinyl)ethyl]-1-isopropenylbenzene,
3-[2-(1-piperidinyl)ethyl]-1-isopropenylbenzene,
3-[2-(1-hexamethyleneimino)ethyl]-1-isopropenylbenzene.

Among the compounds represented by formula (2-1), examples of the compound wherein R²¹ is a vinyl group, m is 0, and A² is a substituted amino group include the following compounds:
2-dimethylamino-1,3-butadiene,
2-diethylamino-1,3-butadiene,
2-(dipropylamino)-1,3-butadiene,
2-(dibutylamino)-1,3-butadiene,
2-diallylamino-1,3-butadiene,
2-[bis(trimethylsilyl)amino]-1,3-butadiene,
2-[bis(tert-butyl-dimethylsilyl)amino]-1,3-butadiene,
2-(1-aziridinyl)-1,3-butadiene,
2-(1-pyrrolidinyl)-1,3-butadiene,
2-(1-piperidinyl)-1,3-butadiene,
2-(1-hexamethyleneimino)-1,3-butadiene,
2-(1-pyrrolyl)-1,3-butadiene,
2-(1-imidazolyl)-1,3-butadiene.

Among the compounds represented by formula (2-1), examples of the compound wherein R²¹ is a vinyl group, m is 1, R²² is an alkylene group, and A² is a substituted amino group include the following compounds:

Compounds wherein R²² is a methylene group:
2-dimethylaminomethyl-1,3-butadiene,
2-diethylaminomethyl-1,3-butadiene,
2-(di-n-propylaminomethyl)-1,3-butadiene,
2-(di-n-butylaminomethyl)-1,3-butadiene,
2-diallylaminomethyl-1,3-butadiene,
2-[bis(trimethylsilyl)aminomethyl]-1,3-butadiene,
2-[bis(tert-butyl-dimethylsilyl)aminomethyl]-1,3-butadiene,
2-[(1-aziridinyl)methyl]-1,3-butadiene,
2-[(1-pyrrolidinyl)methyl]-1,3-butadiene,
2-[(1-piperidinyl)methyl]-1,3-butadiene,
2-[(1-hexamethyleneimino)methyl]-1,3-butadiene,
1-(2-methylene-3-butenyl)pyrrole,
1-(2-methylene-3-butenyl)imidazole.
   Compounds wherein R²² is an ethylene group:
5-dimethylamino-3-methylene-1-pentene,
5-diethylamino-3-methylene-1-pentene,
5-(di-n-propylamino)-3-methylene-1-pentene,
5-(di-n-butylamino)-3-methylene-1-pentene,
5-diallylamino-3-methylene-1-pentene,
5-bis(trimethylsilyl)amino-3-methylene-1-pentene,
5-bis(tert-butyl-dimethylsilyl)amino-3-methylene-1-pentene,
5-(1-aziridinyl)-3-methylene-1-pentene,
5-(1-pyrrolidinyl)-3-methylene-1-pentene,
5-(1-piperidinyl)-3-methylene-1-pentene,
5-(1-hexamethyleneimino)-3-methylene-1-pentene,
1-(3-methylene-4-pentenyl)pyrrole,
1-(3-methylene-4-pentenyl)imidazole.

Among the compounds represented by formula (2-1), examples of the compound wherein R²¹ is a phenyl group, m is 1, R²² is a phenylene group, and A² is a substituted amino group include the following compounds:
1-(4-dimethylaminophenyl)-1-phenylethylene,
1-(4-diethylaminophenyl)-1-phenylethylene,
1-(4-dipropylaminophenyl)-1-phenylethylene,
1-(4-diisopropylaminophenyl)-1-phenylethylene,
1-(4-dibutylaminophenyl)-1-phenylethylene,
1-(4-diisobutylaminophenyl)-1-phenylethylene,
1-(4-di-tert-butylaminophenyl)-1-phenylethylene,
1-(4-diphenylaminophenyl)-1-phenylethylene,
1-[4-(1-aziridinyl)phenyl]-1-phenylethylene,
1-[4-(1-pyrrolidinyl)phenyl]-1-phenylethylene,
1-[4-(1-piperidinyl)phenyl]-1-phenylethylene,
1-[4-(1-hexamethyleneimino)phenyl]-1-phenylethylene,
1-(4-morpholinophenyl)-1-phenylethylene,
1-{4-[bis(trimethylsilyl)amino]phenyl}-1-phenylethylene,
1-{4-[bis(tert-butyl-dimethylsilyl)amino]phenyl}-1-phenylethylene,
1-{4-[bis(triisopropylsilyl)amino]phenyl}-1-phenylethylene,
1-(3-dimethylaminophenyl)-1-phenylethylene,
1-(3-diethylaminophenyl)-1-phenylethylene,
1-(3-dipropylaminophenyl)-1-phenylethylene,
1-(3-diisopropylaminophenyl)-1-phenylethylene,
1-(3-dibutylaminophenyl)-1-phenylethylene,
1-(3-diisobutylaminophenyl)-1-phenylethylene,
1-(3-di-tert-butylaminophenyl)-1-phenylethylene,
1-(3-diphenylaminophenyl)-1-phenylethylene,
1-[3-(1-aziridinyl)phenyl]-1-phenylethylene,
1-[3-(1-pyrrolidinyl)phenyl]-1-phenylethylene,
1-[3-(1-piperidinyl)phenyl]-1-phenylethylene,
1-[3-(1-hexamethyleneimino)phenyl]-1-phenylethylene,
1-(3-morpholinophenyl)-1-phenylethylene,
1-{3-[bis(trimethylsilyl)amino]phenyl}-1-phenylethylene,
1-{3-[bis(tert-butyl-dimethylsilyl)amino]phenyl}-1-phenylethylene,
1-{3-[bis(triisopropylsilyl)amino]phenyl}-1-phenylethylene.

Among the compounds represented by formula (2-1), examples of the compound wherein R²¹ is a phenyl group, m is 1, R²² is a group represented by formula (2-Ra), and A² is a substituted amino group include the following compounds:

Compounds of formula (2-Ra) wherein i is 1:
1-[4-(dimethylaminomethyl)phenyl]-1-phenylethylene,
1-[4-(diethylaminomethyl)phenyl]-1-phenylethylene,
1-[4-(dipropylaminomethyl)phenyl]-1-phenylethylene,
1-[4-(diisopropylaminomethyl)phenyl]-1-phenylethylene,
1-[4-(dibutylaminomethyl)phenyl]-1-phenylethylene,
1-[4-(diisobutylaminomethyl)phenyl]-1-phenylethylene,
1-[4-(di-tert-butylaminomethyl)phenyl]-1-phenylethylene,
1-[4-(diphenylaminomethyl)phenyl]-1-phenylethylene,
1-[4-(1-aziridinylmethyl)phenyl]-1-phenylethylene,
1-[4-(1-pyrrolidinylmethyl)phenyl]-1-phenylethylene,
1-[4-(1-piperidinylmethyl)phenyl]-1-phenylethylene,
1-[4-(1-hexamethyleneiminomethyl)phenyl]-1-phenylethylene,
1-(4-morpholinomethylphenyl)-1-phenylethylene,
1-{4-[bis(trimethylsilyl)aminomethyl]phenyl}-1-phenylethylene,
1-{4-[bis(tert-butyl-dimethylsilyl)aminomethyl]phenyl}-1-phenylethylene,
1-{4-[bis(triisopropylsilyl)aminomethyl]phenyl}-1-phenyleth ylene.

Among the compounds represented by formula (2-1), examples of the compound wherein R²¹ is a phenyl group, m is 1, R²² is a group represented by formula (2-Rb), and A² is a substituted amino group include the following compounds:

Compounds of formula (2-Rb) wherein j is 1:
1-[3-(dimethylaminomethyl)phenyl]-1-phenylethylene,
1-[3-(diethylaminomethyl)phenyl]-1-phenylethylene,
1-[3-(dipropylaminomethyl)phenyl]-1-phenylethylene,
1-[3-(diisopropylaminomethyl)phenyl]-1-phenylethylene,
1-[3-(dibutylaminomethyl)phenyl]-1-phenylethylene,
1-[3-(diisobutylaminomethyl)phenyl]-1-phenylethylene,
1-[3-(di-tert-butylaminomethyl)phenyl]-1-phenylethylene,
1-[3-(diphenylaminomethyl)phenyl]-1-phenylethylene,
1-[3-(1-aziridinylmethyl)phenyl]-1-phenylethylene,
1-[3-(1-pyrrolidinylmethyl)phenyl]-1-phenylethylene,
1-[3-(1-piperidinylmethyl)phenyl]-1-phenylethylene,
1-[3-(1-hexamethyleneiminomethyl)phenyl]-1-phenylethylene,
1-(3-morpholinomethylphenyl)-1-phenylethylene,
1-{3-[bis(trimethylsilyl)aminomethyl]phenyl}-1-phenylethylene,
1-{3-[bis(tert-butyl-dimethylsilyl)aminomethyl]phenyl}-1-phenylethylene,
1-{3-[bis(triisopropylsilyl)aminomethyl]phenyl}-1-phenyleth ylene.

Among the compounds represented by formula (2-1), examples of the compound wherein R²¹ is a hydrogen atom, m is 0, and A² is a nitrogen-containing heteroalicyclic group include the following compounds:
1-methyl-3-vinylpyrrolidine,
1-methyl-4-vinylpiperidine,
1-methyl-3-vinylhexamethyleneimine,
1-methyl-4-vinylhexamethyleneimine.

Among the compounds represented by formula (2-1), examples of the compound wherein R²¹ is a hydrogen atom, m is 1, R²² is a phenylene group, and A² is a nitrogen-containing heteroalicyclic group include the following compounds:
1-methyl-3-(4-vinylphenyl)pyrrolidine,
1-methyl-4-(4-vinylphenyl)piperidine,
1-methyl-3-(4-vinylphenyl)hexamethyleneimine,
1-methyl-4-(4-vinylphenyl)hexamethyleneimine,
1-methyl-3-(3-vinylphenyl)pyrrolidine,
1-methyl-4-(3-vinylphenyl)piperidine,
1-methyl-3-(3-vinylphenyl)hexamethyleneimine,
1-methyl-4-(3-vinylphenyl)hexamethyleneimine.

Among the compounds represented by formula (2-1), examples of the compound wherein R²¹ is a hydrogen atom, m is 1, R²² is a group represented by formula (2-Ra), and A² is a nitrogen-containing heteroalicyclic group include the following compounds.

Compounds of formula (2-Ra) wherein i is 1:
1-methyl-3-(4-vinylphenylmethyl)pyrrolidine,
1-methyl-4-(4-vinylphenylmethyl)piperidine,
1-methyl-3-(4-vinylphenylmethyl)hexamethyleneimine,
1-methyl-4-(4-vinylphenylmethyl)hexamethyleneimine.
   Compounds of formula (2-Ra) wherein i is 2:
1-methyl-3-[2-(4-vinylphenyl)ethyl]pyrrolidine,
1-methyl-4-[2-(4-vinylphenyl)ethyl]piperidine,
1-methyl-3-[2-(4-vinylphenyl)ethyl]hexamethyleneimine,
1-methyl-4-[2-(4-vinylphenyl)ethyl]hexamethyleneimine.

Among the compounds represented by formula (2-1), examples of the compound wherein R²¹ is a hydrogen atom, m is 1, R²² is a group represented by formula (2-Rb), and A² is a nitrogen-containing heteroalicyclic group include the following compounds.

Compounds of formula (2-Rb) wherein j is 1:
1-methyl-3-(3-vinylphenylmethyl)pyrrolidine,
1-methyl-4-(3-vinylphenylmethyl)piperidine,
1-methyl-3-(3-vinylphenylmethyl)hexamethyleneimine,
1-methyl-4-(3-vinylphenylmethyl)hexamethyleneimine.
   Compounds of formula (2-Rb) wherein j is 2:
1-methyl-3-[2-(3-vinylphenyl)ethyl]pyrrolidine,
1-methyl-4-[2-(3-vinylphenyl)ethyl]piperidine,
1-methyl-3-[2-(3-vinylphenyl)ethyl]hexamethyleneimine,
1-methyl-4-[2-(3-vinylphenyl)ethyl]hexamethyleneimine.

Among the compounds represented by formula (2-1), examples of the compound wherein R²¹ is a methyl group, m is 0, and A² is a nitrogen-containing heteroalicyclic group include the following compounds:
1-methyl-3-isopropenylpyrrolidine,
1-methyl-4-isopropenylpiperidine,
1-methyl-3-isopropenylhexamethyleneimine,
1-methyl-4-isopropenylhexamethyleneimine.

Among the compounds represented by formula (2-1), examples of the compound wherein R²¹ is a methyl group, m is 1, R²² is a phenylene group, and A² is a nitrogen-containing heteroalicyclic group include the following compounds:
1-methyl-3-(4-isopropenylphenyl)pyrrolidine,
1-methyl-4-(4-isopropenylphenyl)piperidine,
1-methyl-3-(4-isopropenylphenyl)hexamethyleneimine,
1-methyl-4-(4-isopropenylphenyl)hexamethyleneimine.

Among the compounds represented by formula (2-1), examples of the compound wherein R²¹ is a methyl group, m is 1, R²² is a group represented by formula (2-Ra), and A² is a nitrogen-containing heteroalicyclic group include the following compounds.

Compounds of formula (2-Ra) wherein i is 1:
1-methyl-3-(4-isopropenylphenylmethyl)pyrrolidine,
1-methyl-4-(4-isopropenylphenylmethyl)piperidine,
1-methyl-3-(4-isopropenylphenylmethyl)hexamethyleneimine,
1-methyl-4-(4-isopropenylphenylmethyl)hexamethyleneimine.
   Compounds of formula (2a) wherein i is 2:
1-methyl-3-[2-(4-isopropenylphenyl)ethyl]pyrrolidine,
1-methyl-4-[2-(4-isopropenylphenyl)ethyl]piperidine,
1-methyl-3-[2-(4-isopropenylphenyl)ethyl]hexamethyleneimine,
1-methyl-4-[2-(4-isopropenylphenyl)ethyl]hexamethyleneimine.

Among the compounds represented by formula (2-1), examples of the compound wherein R²¹ is a vinyl group, m is 0, and A² is a nitrogen-containing heteroalicyclic group include the following compounds:
1-methyl-3-(1-methylene-2-propenyl)pyrrolidine,
1-methyl-4-(1-methylene-2-propenyl)piperidine,
1-methyl-3-(1-methylene-2-propenyl)hexamethyleneimine,
1-methyl-4-(1-methylene-2-propenyl)hexamethyleneimine.

Among the compounds represented by formula (2-1), examples of the compound wherein R²¹ is a vinyl group, m is 1, R²² is an alkylene group, and A² is a nitrogen-containing heteroalicyclic group include the following compounds:

Compounds wherein R²² is a methylene group:
1-methyl-3-(2-methylene-3-butenyl)pyrrolidine,
1-methyl-4-(2-methylene-3-butenyl)piperidine,
1-methyl-3-(2-methylene-3-butenyl)hexamethyleneimine,
1-methyl-4-(2-methylene-3-butenyl)hexamethyleneimine.
   Compounds wherein R²² is an ethylene group:
1-methyl-3-(3-methylene-4-pentenyl)pyrrolidine,
1-methyl-4-(3-methylene-4-pentenyl)piperidine,
1-methyl-3-(3-methylene-4-pentenyl)hexamethyleneimine,
1-methyl-4-(3-methylene-4-pentenyl)hexamethyleneimine.

Among the compounds represented by formula (2-1), examples of the compound wherein R²¹ is a phenyl group, m is 1, R²² is a phenylene group, and A² is a nitrogen-containing heteroalicyclic group include the following compounds:
1-[4-(1-methyl-3-pyrrolidinyl)phenyl]-1-phenylethylene,
1-[4-(1-methyl-3-piperidinyl)phenyl]-1-phenylethylene,
1-[4-(1-methyl-4-piperidinyl)phenyl]-1-phenylethylene,
1-[4-(1-methyl-3-hexamethyleneimino)phenyl]-1-phenylethylene,
1-[4-(1-methyl-4-hexamethyleneimino)phenyl]-1-phenylethylene,
1-[3-(1-methyl-3-pyrrolidinyl)phenyl]-1-phenylethylene,
1-[3-(1-methyl-3-piperidinyl)phenyl]-1-phenylethylene,
1-[3-(1-methyl-4-piperidinyl)phenyl]-1-phenylethylene,
1-[3-(1-methyl-3-hexamethyleneimino)phenyl]-1-phenylethylene,
1-[3-(1-methyl-4-hexamethyleneimino)phenyl]-1-phenylethylene.

Among the compounds represented by formula (2-1), examples of the compound wherein R²¹ is a phenyl group, m is 1, R²² is a group represented by formula (2-Ra), and A² is a nitrogen-containing heteroalicyclic group include the following compounds.

Compounds of formula (2-Ra) wherein i is 1:
1-[4-(1-methyl-3-pyrrolidinyl)methyl]phenyl}-1-phenylethylene,
1-[4-(1-methyl-3-piperidinyl)methyl]phenyl}-1-phenylethylene,
1-[4-(1-methyl-4-piperidinyl)methyl]phenyl}-1-phenylethylene,
1-[4-(1-methyl-3-hexamethyleneimino)methyl]phenyl}-1-phenyl ethylene,

Among the compounds represented by formula (2-1), examples of the compound wherein R²¹ is a phenyl group, m is 1, R²² is a group represented by formula (2-Rb), and A² is a nitrogen-containing heteroalicyclic group include the following compounds.

Compounds of formula (2-Rb) wherein j is 1:
1-[3-(1-methyl-3-pyrrolidinyl)methyl]phenyl}-1-phenylethylene,
1-[3-(1-methyl-3-piperidinyl)methyl]phenyl}-1-phenylethylene,
1-[3-(1-methyl-4-piperidinyl)methyl]phenyl}-1-phenylethylene,
1-[3-(1-methyl-3-hexamethyleneimino)methyl]phenyl}-1-phenyl ethylene.

Among the compounds represented by formula (2-1), examples of the compound wherein R²¹ is a hydrogen atom, m is 0, and A² is a nitrogen-containing aromatic heterocyclic group include the following compounds:
1-methyl-2-vinylimidazole,
1-methyl-4-vinylimidazole,
1-methyl-5-vinylimidazole,
2-vinylpyridine,
3-vinylpyridine,
4-vinylpyridine,
2-vinylquinoline,
3-vinylquinoline,
4-vinylquinoline.

Among the compounds represented by formula (2-1), examples of the compound wherein R²¹ is a methyl group, m is 0, and A² is a nitrogen-containing aromatic heterocyclic group include the following compounds:
1-methyl-2-isopropenylimidazole,
1-methyl-4-isopropenylimidazole,
1-methyl-5-isopropenylimidazole,
2-isopropenylpyridine,
3-isopropenylpyridine,
4-isopropenylpyridine,
2-isopropenylquinoline,
3-isopropenylquinoline,
4-isopropenylquinoline.

Among the compounds represented by formula (2-1), examples of the compound wherein R²¹ is a vinyl group, m is 0, and A² is a nitrogen-containing aromatic heterocyclic group include the following compounds:
1-methyl-2-(1-methylene-2-propenyl)imidazole,
1-methyl-4-(1-methylene-2-propenyl)imidazole,
1-methyl-5-(1-methylene-2-propenyl)imidazole,
2-(1-methylene-2-propenyl)pyridine,
3-(1-methylene-2-propenyl)pyridine,
4-(1-methylene-2-propenyl)pyridine,
2-(1-methylene-2-propenyl)quinoline,
3-(1-methylene-2-propenyl)quinoline,
4-(1-methylene-2-propenyl)quinoline.

Among the compounds represented by formula (2-1), examples of the compound wherein R²¹ is a vinyl group, m is 1, R²² is an alkylene group, and A² is a nitrogen-containing aromatic heterocyclic group include the following compounds:

Compounds wherein R²² is a methylene group:
1-methyl-2-(2-methylene-3-butenyl)imidazole,
1-methyl-4-(2-methylene-3-butenyl)imidazole,
1-methyl-5-(2-methylene-3-butenyl)imidazole,
2-(2-methylene-3-butenyl)pyridine,
3-(2-methylene-3-butenyl)pyridine,
4-(2-methylene-3-butenyl)pyridine,
2-(2-methylene-3-butenyl)quinoline,
3-(2-methylene-3-butenyl)quinoline,
4-(2-methylene-3-butenyl)quinoline.
   Compounds wherein R²² is an ethylene group:
1-methyl-2-(3-methylene-4-pentenyl)imidazole,
1-methyl-4-(3-methylene-4-pentenyl)imidazole,
1-methyl-5-(3-methylene-4-pentenyl)imidazole,
2-(3-methylene-4-pentenyl)pyridine,
3-(3-methylene-4-pentenyl)pyridine,
4-(3-methylene-4-pentenyl)pyridine,
2-(3-methylene-4-pentenyl)quinoline,
3-(3-methylene-4-pentenyl)quinoline,
4-(3-methylene-4-pentenyl)quinoline.

Preferred as the compound represented by formula (2) is a compound represents by formula (2-1) wherein R²¹ in formula (2-1) is a hydrogen atom.

More preferred are:

a compound represented by formula (2-1) wherein R²¹ in formula (2-1) is a hydrogen atom, m is 1, R²² is a phenylene group, and A² is a substituted amino group represented by formula (2-A);
a compound represented by formula (2-1) wherein R²¹ in formula (2-1) is a hydrogen atom, m is 1, R²² is a group represented by formula (2-R), and A² is a substituted amino group represented by formula (2-A); and
a compound represented by formula (2-1) wherein R²¹ in formula (2-1) is a hydrogen atom, m is 0, and A² is a nitrogen-containing heterocyclic group.

Further preferred are:

a compound represented by formula (2-1) wherein R²¹ in formula (2-1) is a hydrogen atom, m is 1, R²² is a para-phenylene group or a meta-phenylene group, and A² is a polymethylene group wherein R²⁵ and R²⁶ in formula (2-A) are bonded to each other;
a compound represented by formula (2-1) wherein R²¹ in formula (2-1) is a hydrogen atom, m is 1, R²² is a group represented by formula (2-Ra) or (2-Rb), and A² is a polymethylene group wherein R²⁵ and R²⁶ in formula (2-A) are bonded to each other; and
a compound represented by formula (2-1) wherein R²¹ in formula (2-1) is a hydrogen atom, m is 0, and A² is a nitrogen-containing aromatic heterocyclic group.

Particularly preferred as the compound represented by formula (2) are:
4-[2-(1-pyrrolidinyl)ethyl]styrene,
3-[2-(1-pyrrolidinyl)ethyl]styrene,
4-vinylpyridine, and
3-vinylpyridine.

The second one of the compounds included in the monomers to be polymerized in the method for producing a conjugated diene-based polymer of the present invention is a compound represented by the following formula (3),

E³-A³ (3)

wherein E³ represents a hydrocarbyl group having a polymerizable carbon-carbon double bond, and A³ represents a substituted silyl group.

E³ in formula (3) represents a hydrocarbyl group having a polymerizable carbon-carbon double bond.

E³ is preferably a group represented by the following formula (3-E).

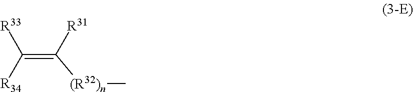

wherein n represents an integer of 0 or 1, R³¹, R³³ and R³⁴ each independently represent a hydrogen atom or a hydrocarbyl group, and R³² represents a hydrocarbylene group.

In formula (3-E), n represents an integer of 0 or 1.

Examples of the hydrocarbyl groups of R³¹, R³³ and R³⁴ include an alkyl group, an alkenyl group, and an aryl group. Examples of the alkyl group include a methyl group, an ethyl group, a n-propyl group, an isopropyl group, a n-butyl group, a sec-butyl group, and a tert-butyl group, and preferred is a methyl group. Examples of the alkenyl group include a vinyl group, an allyl group, a 1-propenyl group, and an isopropenyl group, and preferred is a vinyl group. Examples of the aryl group include a phenyl group, a methylphenyl group, and an ethylphenyl group, and preferred is a phenyl group.

Preferred as R³¹ are a hydrogen atom, a methyl group, a vinyl group, and a phenyl group, and more preferred is a hydrogen atom.

Preferred as R³³ and R³⁴ is a hydrogen atom.

Examples of the hydrocarbylene group of R³² include an alkylene group, an arylene group, and a group in which an arylene group is bonded to an alkylene group.

Examples of the alkylene group include a methylene group, an ethylene group, and a trimethylene group. Preferred is a methyl group or an ethyl group. Examples of the arylene group include a phenylene group, a naphthylene group, and a biphenylene group. Preferred is a phenylene group.

Examples of the group in which an arylene group is bonded to an alkylene group include a group in which a phenylene group is bonded to an alkylene group, a group in which a naphthylene group is bonded to an alkylene group, and a group in which a biphenylene group is bonded to an alkylene group. Preferred is a group in which a phenylene group is bonded to an alkylene group.

As to the group in which an arylene group is bonded to an alkylene group, a carbon atom of the arylene group is preferably attached to the carbon atom to which R³¹ of formula (3-E) is attached.

Examples of the group in which a phenylene group and an alkylene group are bonded to each other (i.e., a phenylene-alkylene group) include a group represented by the following formula (3-R),

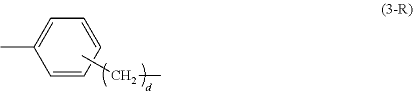

wherein d represents an integer of 1 to 10, and (CH₂)_{d} is a substituent on the benzene ring.

Examples of the phenylene-alkylene group include, depending upon the position of the benzene ring carbon atom to which the alkylene group is attached, a para-phenylene-alkylene group, a meta-phenylene-alkylene group, and an ortho-phenylene-alkylene group. In the case of a group represented by formula (3-R), the para-phenylene-alkylene group is a group represented by the following formula (3-Ra), the meta-phenylene-alkylene group is a group represented by the following (3-Rb), and the ortho-phenylene-alkylene group is a group represented by the following formula (3-Rc),

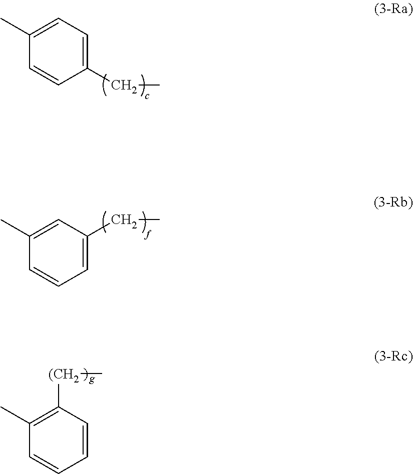

wherein e, f, and g each represent an integer of 1 to 10.

Preferred as the group in which an arylene group is bonded to an alkylene group is a group in which a phenylene group is bonded to an alkylene group (a phenylene-alkylene group), more preferred is a group represented by the above formula (3-Ra) or a group represented by the above formula (3-Rb), even more preferred is a para-phenylene-methylene group (a group represented by formula (3-Ra) wherein e=1), a meta-phenylene-methylene group (a group represented by formula (3-Rb) wherein f=1), a para-phenylene-ethylene group (a group represented by formula (3-Ra) wherein e=2), or a meta-phenylene-ethylene group (a group represented by formula (3-Rb) wherein f=2).

Examples of the group represented by formula (3-E) include the groups shown below.

Examples of the group wherein R³¹, R³³ and R³⁴ are hydrogen atoms include a vinyl group, an allyl group, a 3-butenyl group, a 4-vinylphenyl group, a 3-vinylphenyl group, a (4-vinylphenyl)methyl group, a 2-(4-vinylphenyl)ethyl group, a (3-vinylphenyl)methyl group, and a 2-(3-vinylphenyl)ethyl group.

Examples of the group wherein R³¹ is a methyl group and R³³ and R³⁴ are hydrogen atoms include an isopropenyl group, a 2-methyl-2-propenyl group, a 4-isopropenylphenyl group, a 3-isopropenylphenyl group, a (4-isopropenylphenyl)methyl group, a 2-(4-isopropenylphenyl)ethyl group, a (3-isopropenylphenyl)methyl group, and a 2-(3-isopropenylphenyl)ethyl group.

Examples of the group in which R³¹ is a vinyl group and R³³ and R³⁴ are hydrogen atoms include a 1-methylene-2-propenyl group and a 2-methylene-3-butenyl group.

Examples of the group in which R³¹ is a phenyl group and R³³ and R³⁴ are hydrogen atoms include a 1-phenylethenyl group, a 2-phenyl-2-propenyl group, a 4-(1-phenylethenyl)phenyl group, a 3-(1-phenylethenyl)phenyl group, and a 2-(1-phenylethenyl)phenyl group.

Examples of the group in which R³¹ is a hydrogen atom, R³³ is a methyl group, and R³⁴ is a hydrogen atom include a 1-propenyl group, a 2-butenyl group, a 4-(1-propenyl)phenyl group, a 4-(1-propenyl)phenylmethyl group, a 2-[4-(1-propenyl)phenyl]ethyl group, a 3-(1-propenyl)phenyl group, a 3-(1-propenyl)phenylmethyl group, and a 2-[3-(1-propenyl)phenyl]ethyl group.

The group represented by formula (3-E) is preferably a group represented by the following formula (3-E1),

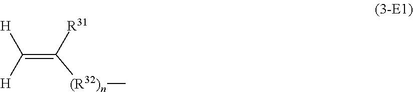

wherein R³¹ represents a hydrogen atom or a hydrocarbyl group, n represents an integer of 0 or 1, and R³² represents a hydrocarbylene group.

Among preferable groups represented by formula (3-E1), examples of the group wherein R³¹ is a hydrogen atom include a vinyl group, a 4-vinylphenyl group, a 3-vinylphenyl group, a (4-vinylphenyl)methyl group, a 2-(4-vinylphenyl)ethyl group, a (3-vinylphenyl)methyl group, and 2-(3-vinylphenyl)ethyl group. Examples of the group wherein R³¹ is a methyl group include a 4-isopropenylphenyl group, a 3-isopropenylphenyl group, a (4-isopropenylphenyl)methyl group, a 2-(4-isopropenylphenyl)ethyl group, a (3-isopropenylphenyl)methyl group, and a 2-(3-isopropenylphenyl)ethyl group. Examples of the group wherein R³¹ is a vinyl group include a 1-methylene-2-propenyl group and a 2-methylene-3-butenyl group. Examples of the group wherein R³¹ is a phenyl group include a 4-(1-phenylvinyl)phenyl group.

More preferred as the group represented by formula (3-E1) is a vinyl group.

A³ in formula (3) represents a substituted silyl group.

Examples of the substituted silyl group represented by A³ include groups in which a hydrogen atom attached to the silicon atom of a silyl group has been substituted with a substituent such as a hydrocarbyl group optionally having a substituent, a hydrocarbyloxy group, and a substituted amino group. Substituents attached to the silicon atom may be either the same or different.

Preferred as the substituted silyl group represented by A³ is a group represented by the following formula (3-A),

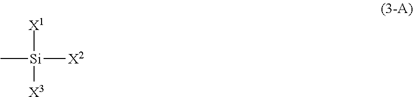

wherein X¹, X² and X³ each represent a substituted amino group or a hydrocarbyl group optionally having a substituent, provided that at least one of X¹, X² and X³ is a substituted amino group.

Examples of the hydrocarbyl groups optionally having a substituent of X¹, X² and X³ include a hydrocarbyl group and a substituted hydrocarbyl group, and examples of the substituted hydrocarbyl group include a group having at least one atom selected from the atom group consisting of an oxygen atom, a nitrogen atom, and a silicon atom.

Examples of the hydrocarbyl groups of X¹, X² and X³ include an alkyl group, an alkenyl group, an alkynyl group, an aryl group, and an aralkyl group. Examples of the alkyl group include a methyl group, an ethyl group, a n-propyl group, an isopropyl group, a n-butyl group, a sec-butyl group, and a tert-butyl group. Examples of the alkenyl group include a vinyl group, an allyl group, a 1-propenyl group, and an isopropenyl group. Examples of the alkynyl group include an ethynyl group and a 2-propynyl group. Examples of the aryl group include a phenyl group, a tolyl group, and a xylyl group. Examples of the aralkyl group include a benzyl group. Preferred as the hydrocarbyl group is an alkyl group.

Examples of the substituted hydrocarbyl groups having an oxygen atom of X¹, X² and X³ include alkoxyalkyl groups such as a methoxymethyl group, a methoxyethyl group, an ethoxymethyl group, and an ethoxyethyl group.

Examples of the substituted hydrocarbyl groups having a nitrogen atom of X¹, X² and X³ include dialkylaminoalkyl groups such as a dimethylaminomethyl group, a dimethylaminoethyl group, a diethylaminomethyl group, and a diethylaminoethyl group.

Examples of the substituted hydrocarbyl groups having a silicon atom of X¹, X² and X³ include trialkylsilylalkyl groups such as a trimethylsilylmethyl group, a trimethylsilylethyl group, a triethylsilylmethyl group, and a triethylsilylethyl group.

The number of the carbon atoms of each of the hydrocarbyl groups optionally having a substituent of X¹, X² and X³ is preferably 1 to 10, and more preferably 1 to 4.

Preferred as the hydrocarbyl groups optionally having a substituent of X¹, X² and X³, is an alkyl group or an alkoxyalkyl group. Preferred as the alkyl group is an alkyl group having 1 to 4 carbon atoms, and more preferred is a methyl group or an ethyl group. Preferred as the alkoxyalkyl group is an alkoxyalkyl group having 2 to 4 carbon atoms.

Preferred as the substituted amino groups of X¹, X² and X³ is a group represented by the following formula (3-X),

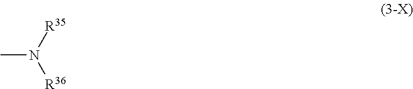

wherein R³⁵ and R³⁶ are each a hydrocarbyl group or a trihydrocarbylsilyl group, or R³⁵ is bonded to R³⁶ and the group in which R³⁵ is bonded to R³⁶ represents a hydrocarbylene group optionally having a nitrogen atom and/or an oxygen atom as a hetero atom, or R³⁵ and R³⁶ represent together one group that is bonded to the nitrogen atom via a double bond.

Examples of the hydrocarbyl groups of R³⁵ and R³⁶ include an alkyl group, an alkenyl group, an alkynyl group, an aryl group, and an aralkyl group. Examples of the alkyl group include a methyl group, an ethyl group, a n-propyl group, an isopropyl group, a n-butyl group, a sec-butyl group, and a tert-butyl group. Examples of the alkenyl group include a vinyl group, an allyl group, a 1-propenyl group, and an isopropenyl group. Examples of the alkynyl group include an ethynyl group and a 2-propynyl group. Examples of the aryl group include a phenyl group, a tolyl group, and a xylyl group. Examples of the aralkyl group include a benzyl group.

The number of the carbon atoms of each of the hydrocarbyl groups of R³⁵ and R³⁶ is preferably 1 to 10, more preferably 1 to 4, and even more preferably 1 to 2.

Preferred as the hydrocarbyl groups of R³⁵ and R³⁶ is an alkyl group, and a linear alkyl group is more preferred.

Examples of the trihydrocarbylsilyl groups of R³⁵ and R³⁶ include trialkylsilyl groups such as a trimethylsilyl group, a triethylsilyl group, a triisopropylsilyl group, and a tert-butyl-dimethylsilyl group.

The trihydrocarbylsilyl groups of R³⁵ and R³⁶ are each preferably a trialkylsilyl group having 3 to 9 carbon atoms, more preferably a trialkylsilyl group in which the alkyl group attached to the silicon atom is an alkyl group having 1 to 3 carbon atoms, and even more preferably a trimethylsilyl group.

In the group in which R³⁵ is bonded to R³⁶, examples of the hydrocarbylene group optionally having a nitrogen atom and/or an oxygen atom as a hetero atom include a hydrocarbylene group, a hydrocarbylene group having a nitrogen atom, and a hydrocarbylene group having an oxygen atom. Examples of the hydrocarbylene group include alkylene groups such as an ethylene group, a trimethylene group, a tetramethylene group, a pentamethylene group, and a hexamethylene group. Examples of the hydrocarbylene group having a nitrogen atom include a group represented by —CH₂CH₂—NH—CH₂—, a group represented by —CH₂CH₂—N═CH—, a group represented by —CH═CH—N═CH—, and a group represented by —CH₂CH₂—NH—CH₂CH₂—. Examples of the hydrocarbylene group having an oxygen atom include a group represented by —CH₂CH₂—O—CH₂CH₂—.

The number of the carbon atoms of the group in which R³⁵ is bonded to R³⁶ is preferably 2 to 20, more preferably 2 to 7, and even more preferably 4 to 6.

In the group in which R³⁵ is bonded to R³⁶, the hydrocarbylene group optionally having a nitrogen atom and/or an oxygen atom as a hetero atom is preferably a hydrocarbylene group, more preferably an alkane group, even more preferably a polymethylene group.

Examples of the group in which R³⁵ and R³⁶ are bonded to the nitrogen atom via a double bond include hydrocarbylidene groups such as an ethylidene group, a propylidene group, a butylidene group, a 1-methylethylidene group, a 1-methylpropylidene group, and a 1,3-dimethylbutylidene group.

The numbers of the carbon atoms of the group in which R³⁵ and R³⁶ are bonded to the nitrogen atom via a double bond is preferably 2 to 20, and more preferably 2 to 6.

Preferably, R³⁵ and R³⁶ are each an alkyl group or a trialkylsilyl group, or R³⁵ is bonded to R³⁶ and the group in which R³⁵ is bonded to R³⁶ is an alkylene group, and more preferably, R³⁵ and R³⁶ are each an alkyl group.

Examples of the group represented by formula (3-X) include an acyclic amino group and a cyclic amino group.

Among acyclic amino groups, examples of the group of formula (3-X) wherein R³⁵ and R³⁶ are each a hydrocarbyl group include dialkylamino groups such as a dimethylamino group, a diethylamino group, a di(n-propylamino) group, a di(isopropyl)amino group, a di(n-butyl)amino group, a di(sec-butyl)amino group, a di(tert-butyl)amino group, and an ethylmethylamino group. Among acyclic amino groups, examples of the group of formula (3-X) in which R³⁵ and R³⁶ are each a trihydrocarbylsilyl group include bis(trialkylsilyl)amino groups such as a bis(trimethylsilyl)amino group and a bis(tert-butyl-dimethylsilyl)amino group.

Among acyclic amino groups, examples of the group of formula (3-X) in which R³⁵ and R³⁶ represent together one group that is bonded to the nitrogen atom via a double bond include an ethylideneamino group, a 1-methylpropylideneamino group, a 1,3-dimethylbutylideneamino group, a 1-methylethylideneamino group, and a 4-N,N-dimethylaminobenzylideneamino group.

Among such cyclic amino groups, examples of a group of formula (3-X) in which R³⁵ is bonded to R³⁶ and the group in which R³⁵ is bonded to R³⁶ is a hydrocarbylene group include a 1-aziridinyl group, a 1-azetidinyl group, a 1-pyrrolidinyl group, a 1-piperidinyl group, a 1-hexamethyleneimino group, and a 1-pyrrolyl group.

Among cyclic amino groups, examples of a group of formula (3-X) wherein R³⁵ is bonded to R³⁶ and the group in which R³⁵ is bonded to R³⁶ is a hydrocarbylene group containing a nitrogen atom as a hetero atom include a 1-imidazolyl group, a 4,5-dihydro-1-imidazolyl group, a 1-imidazolidinyl group, and a 1-piperazinyl group.

Among cyclic amino groups, examples of a group of formula (3-X) wherein R³⁵ is bonded to R³⁶ and the group in which R³⁵ is bonded to R³⁶ is a hydrocarbylene group containing an oxygen atom as a hetero atom include a morpholino group.

The substituted amino groups of X¹, X² and X³ are each preferably an acyclic amino group, and more preferably is a dialkylamino group. More preferred is a dimethylamino group, a diethylamino group, a di(n-propyl)amino group, or a di(n-butyl)amino group, and particularly preferred is a dimethylamino group or a diethylamino group.

In formula (3-A), at least one of X¹, X² and X³ is a substituted amino group, and preferably, two or more of X¹, X² and X³ are substituted amino groups, and more preferably, two of X¹, X² and X³ are substituted amino groups.

The compound represented by formula (3) is preferably a compound represented by the following formula (3-1) wherein E³ is a group represented by formula (3-E1) and A³ is a group represented by formula (3-A),

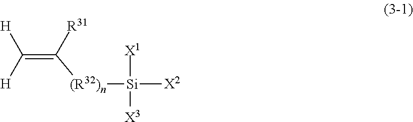

wherein R³¹ represents a hydrogen atom or a hydrocarbyl group, n represents an integer of 0 or 1, R³² represents a hydrocarbylene group, and X¹, X² and X³ each represent a substituted amino group or a hydrocarbyl group optionally having a substituent, provided that at least one of X¹, X² and X³ is a substituted amino group.

Among the compounds represented by formula (3-1), examples of the compound wherein R³¹ is a hydrogen atom and one of X¹, X² and X³ is a dialkylamino group include the following compounds.

Compounds of formula (3-1) wherein n is 0:
(dimethylamino)dimethylvinylsilane,
(diethylamino)dimethylvinylsilane,
(dipropylamino)dimethylvinylsilane,
(dibutylamino)dimethylvinylsilane,
(dimethylamino)diethylvinylsilane,
(diethylamino)diethylvinylsilane,
(dipropylamino)diethylvinylsilane,
(dibutylamino)diethylvinylsilane.
   Compounds of formula (3-1) wherein n is 1:
(dimethylamino)dimethyl(4-vinylphenyl)silane,
(dimethylamino)dimethyl(3-vinylphenyl)silane,
(diethylamino)dimethyl(4-vinylphenyl)silane,
(diethylamino)dimethyl(3-vinylphenyl)silane,
(dipropylamino)dimethyl(4-vinylphenyl)silane,
(dipropylamino)dimethyl(3-vinylphenyl)silane,
(dibutylamino)dimethyl(4-vinylphenyl)silane,
(dibutylamino)dimethyl(3-vinylphenyl)silane,
(dimethylamino)diethyl(4-vinylphenyl)silane,
(dimethylamino)diethyl(3-vinylphenyl)silane,
(diethylamino)diethyl(4-vinylphenyl)silane,
(diethylamino)diethyl(3-vinylphenyl)silane,
(dipropylamino)diethyl(4-vinylphenyl)silane,
(dipropylamino)diethyl(3-vinylphenyl)silane,
(dibutylamino)diethyl(4-vinylphenyl)silane,
(dibutylamino)diethyl(3-vinylphenyl)silane.

Among the compounds represented by formula (3-1), examples of the compound wherein R³¹ is a hydrogen atom and two of X¹, X² and X³ are dialkylamino groups include the following compounds.

Compounds of formula (3-1) wherein n is 0:
bis(dimethylamino)methylvinylsilane,
bis(diethylamino)methylvinylsilane,
bis(dipropylamino)methylvinylsilane,
25 bis(dibutylamino)methylvinylsilane,
bis(dimethylamino)ethylvinylsilane,
bis(diethylamino)ethylvinylsilane,
bis(dipropylamino)ethylvinylsilane,
bis(dibutylamino)ethylvinylsilane.
   Compounds of formula (3-1) wherein n is 1:
bis(dimethylamino)methyl(4-vinylphenyl)silane,
bis(dimethylamino)methyl(3-vinylphenyl)silane,
bis(diethylamino)methyl(4-vinylphenyl)silane,
bis(diethylamino)methyl(3-vinylphenyl)silane,
bis(dipropylamino)methyl(4-vinylphenyl)silane,
bis(dipropylamino)methyl(3-vinylphenyl)silane,
bis(dibutylamino)methyl(4-vinylphenyl)silane,
bis(dibutylamino)methyl(3-vinylphenyl)silane,
bis(dimethylamino)ethyl(4-vinylphenyl)silane,
bis(dimethylamino)ethyl(3-vinylphenyl)silane,
bis(diethylamino)ethyl(4-vinylphenyl)silane,
bis(diethylamino)ethyl(3-vinylphenyl)silane,
bis(dipropylamino)ethyl(4-vinylphenyl)silane,
bis(dipropylamino)ethyl(3-vinylphenyl)silane,
bis(dibutylamino)ethyl(4-vinylphenyl)silane,
bis(dibutylamino)ethyl(3-vinylphenyl)silane.

Among the compounds represented by formula (3-1), examples of the compound wherein R³¹ is a methyl group and two of X¹, X² and X³ are dialkylamino groups include the following compounds.

Compounds of formula (3-1) wherein n is 1:
bis(dimethylamino)methyl(4-isopropenylphenyl)silane,
bis(dimethylamino)methyl(3-isopropenylphenyl)silane,
bis(dimethylamino)methyl(4-isopropenylphenyl)silane,
bis(diethylamino)methyl(3-isopropenylphenyl)silane,
bis(dipropylamino)methyl(4-isopropenylphenyl)silane,
bis(dipropylamino)methyl(3-isopropenylphenyl)silane,
bis(dibutylamino)methyl(4-isopropenylphenyl)silane,
bis(dibutylamino)methyl(3-isopropenylphenyl)silane,
bis(dimethylamino)ethyl(4-isopropenylphenyl)silane,
bis(dimethylamino)ethyl(3-isopropenylphenyl)silane,
bis(diethylamino)ethyl(4-isopropenylphenyl)silane,
bis(diethylamino)ethyl(3-isopropenylphenyl)silane,
bis(dipropylamino)ethyl(4-isopropenylphenyl)silane,
bis(dipropylamino)ethyl(3-isopropenylphenyl)silane,
bis(dibutylamino)ethyl(4-isopropenylphenyl)silane,
bis(dibutylamino)ethyl(3-isopropenylphenyl)silane.

Among the compounds represented by formula (3-1), examples of the compound wherein R³¹ is a vinyl group and two of X¹, X² and X³ are dialkylamino groups include the following compounds.

Compounds of formula (3-1) wherein n is 0:
bis(dimethylamino)methyl(1-methylene-2-propenyl)silane,
bis(diethylamino)methyl(1-methylene-2-propenyl)silane,
bis(dipropylamino)methyl(1-methylene-2-propenyl)silane,
bis(dibutylamino)methyl(1-methylene-2-propenyl)silane,
bis(dimethylamino)ethyl(1-methylene-2-propenyl)silane,
bis(diethylamino)ethyl(1-methylene-2-propenyl)silane,
bis(dipropylamino)ethyl(1-methylene-2-propenyl)silane,
bis(dibutylamino)ethyl(1-methylene-2-propenyl)silane.

Among the compounds represented by formula (3-1), examples of the compound wherein R³¹ is a phenyl group and two of X¹, X² and X³ are dialkylamino groups include the following compounds.

Compounds of formula (3-1) wherein n is 1:
1-{4-[bis(dimethylamino)methylsilyl]phenyl}-1-phenylethylene,
1-{4-[bis(diethylamino)methylsilyl]phenyl}-1-phenylethylene,
1-{4-[bis(dipropylamino)methylsilyl]phenyl}-1-phenylethylene,
1-{4-[bis(dibutylamino)methylsilyl]phenyl}-1-phenylethylene,
1-{4-[bis(dimethylamino)ethylsilyl]phenyl}-1-phenylethylene,
1-{4-[bis(diethylamino)ethylsilyl]phenyl}-1-phenylethylene,
1-{4-[bis(dipropylamino)ethylsilyl]phenyl}-1-phenylethylene,
1-{4-[bis(dibutylamino)ethylsilyl]phenyl}-1-phenylethylene.

Among the compounds represented by formula (3-1), examples of the compound wherein R³¹ is a hydrogen atom and three of X¹, X² and X³ are dialkylamino groups include the following compounds.

Compounds of formula (3-1) wherein n is 0:
tris(dimethylamino)vinylsilane,
tris(diethylamino)vinylsilane,
tris(dipropylamino)vinylsilane,
tris(dibutylamino)vinylsilane,
   Compounds of formula (3-1) wherein n is 1:
tris(dimethylamino) (4-vinylphenyl)silane,
tris(dimethylamino)(3-vinylphenyl)silane,
tris(diethylamino)(4-vinylphenyl)silane,
tris(diethylamino)(3-vinylphenyl)silane,
tris(dipropylamino)(4-vinylphenyl)silane,
tris(dipropylamino) (3-vinylphenyl)silane,
tris(dibutylamino)(4-vinylphenyl)silane,
tris(dibutylamino)(3-vinylphenyl)silane.

Among the compounds represented by formula (3-1), examples of the compound wherein R³¹ is a methyl group and three of X¹, X² and X³ are dialkylamino groups include the following compounds.

Compounds of formula (3-1) wherein n is 1:
tris(dimethylamino) (4-isopropenylphenyl)silane,
tris(dimethylamino)(3-isopropenylphenyl)silane,
tris(diethylamino)(4-isopropenylphenyl)silane,
tris(diethylamino)(3-isopropenylphenyl)silane,
tris(dipropylamino)(4-isopropenylphenyl)silane,
tris(dipropylamino) (3-isopropenylphenyl)silane,
tris(dibutylamino)(4-isopropenylphenyl)silane,
tris(dibutylamino)(3-isopropenylphenyl)silane.

Among the compounds represented by formula (3-1), examples of the compound wherein R³¹ is a vinyl group and three of X¹, X² and X³ are dialkylamino groups include the following compounds.

Compounds of formula (3-1) wherein n is 0:
tris(dimethylamino)(1-methylene-2-propenyl)silane,
tris(diethylamino)(1-methylene-2-propenyl)silane,
tris(dipropylamino)(1-methylene-2-propenyl)silane,
tris(dibutylamino)(1-methylene-2-propenyl)silane.

Among the compounds represented by formula (3-1), examples of the compound wherein R³¹ is a phenyl group and three of X¹, X² and X³ are dialkylamino groups include the following compounds.

Compounds of formula (3-1) wherein n is 1:
1-[4-tris(dimethylamino)silylphenyl]-1-phenylethylene,
1-[4-tris(diethylamino)silylphenyl]-1-phenylethylene,
1-{4-tris(di-n-propylamino)methylsilylphenyl]-1-phenylethylene,
1-{4-tris(di-n-butylamino)methylsilylphenyl]-1-phenylethylene.

Preferred as the compound represented by formula (3) is a compound represented by formula (3-1), more preferred is a compound represented by formula (3-1) wherein two of X¹, X² and X³ in formula (3-1) are dialkylamino groups, and even more preferred is a compound represented by formula (3-1) wherein two of X¹, X² and X³ in formula (3-1) are dialkylamino groups, R³¹ is a hydrogen atom, and n=0.

Particularly preferred as the compound represented by formula (3) is a compound represented by formula (3-1) wherein two of X¹, X² and X³ in formula (3-1) are dialkylamino groups, the remaining one is an alkyl group or an alkoxyalkyl group, R³¹ is a hydrogen atom, and n=0.

Most preferred as the compound represented by formula (3) are:
bis(dimethylamino)methylvinylsilane,
bis(diethylamino)methylvinylsilane,
bis(dipropylamino)methylvinylsilane,
bis(dibutylamino)methylvinylsilane,
bis(dimethylamino)ethylvinylsilane,
bis(diethylamino)ethylvinylsilane,
bis(dipropylamino)ethylvinylsilane, and
bis(dibutylamino)ethylvinylsilane.

The third one of the compounds included in the monomers to be polymerized in the method for producing a conjugated diene-based polymer of the present invention is a conjugated diene compound.

Examples of the conjugated diene compound include 1,3-butadiene, isoprene, 1,3-pentadiene, 2,3-dimethyl-1,3-butadiene, and 1,3-hexadiene, and preferably 1,3-butadiene or isoprene.

In addition to the compound represented by formula (2), the compound represented by formula (3), and the conjugated diene compound, another compound may further be included in the monomers. Preferred as the compound is an aromatic vinyl compound. Examples of the aromatic vinyl compound include styrene, α-methylstyrene, vinyltoluene, vinylnaphthalene, divinylbenzene, trivinylbenzene, and divinylnaphthalene, and styrene is preferred.

The amount of the compound represented by formula (2) in the monomers to be supplied to a polymerization reactor is preferably 0.01% by weight or more in order to improve fuel cost saving properties, more preferably 0.02% by weight or more, and even more preferably 0.15% by weight or more where the overall amount of the monomers to be supplied to the polymerization reactor is taken as 100% by weight. In order to enhance tensile strength at break, the amount of that compound is preferably 20% by weight or less, more preferably 6% by weight or less, and even more preferably 3% by weight or less.

The amount of the compound represented by formula (3) in the monomers to be supplied to a polymerization reactor is preferably 0.01% by weight or more in order to improve fuel cost saving properties, more preferably 0.02% by weight or more, and even more preferably 0.05% by weight or more where the overall amount of the monomers to be supplied to the polymerization reactor is taken as 100% by weight. Moreover, in order to enhance tensile strength at break, the amount of that compound is preferably 20% by weight or less, more preferably 2% by weight or less, and even more preferably 1% by weight or less.

The total amount of the compound represented by formula (2) and the compound represented by formula (3) in the monomers to be supplied to the polymerization reactor is preferably 0.02% by weight or more in order to improve fuel cost saving properties, more preferably 0.04% by weight or more, and even more preferably 0.2% by weight or more where the overall amount of the monomers to be supplied to the polymerization reactor is taken as 100% by weight. Moreover, it is preferably 25% by weight or less, more preferably 7% by weight or less, and even more preferably 3.5% by weight or less.

The weight ratio of the compound represented by formula (3) and the compound represented by formula (2) in the monomers to be supplied to the polymerization reaction (the weight of the compound represented by formula (2)/the weight of the compound represented by formula (3)) is preferably 1/10 or more in order to improve fuel cost saving properties, more preferably 1/1 or more, and even more preferably 3/1 or more. Moreover, it is preferably 10/1 or less, more preferably 7/1 or less, and even more preferably 5/1 or less.

That is, the weight ratio of the compound represented by formula (2) to the compound represented by formula (3) in the monomers to be supplied to the polymerization reaction is preferably 0.1 or more, more preferably 1 or more, and even more preferably 3 or more. Moreover, it is preferably 10 or less, more preferably 7 or less, and even more preferably 5 or less.

The amount of the conjugated diene compound in the monomers to be supplied to a polymerization reactor is preferably 99.98% by weight or less, more preferably 90% by weight or less, and even more preferably 85% by weight or less where the overall amount of the monomers to be supplied to the polymerization reactor is taken as 100% by weight. In order to improve fuel cost saving properties, it is preferably 50% by weight or more, and more preferably 55% by weight or more.

When an aromatic vinyl compound is included in the monomers, the amount of the aromatic vinyl compound in the monomers to be supplied to the polymerization reactor is preferably 9% by weight or more, and more preferably 14% by weight or more where the overall amount of the monomers to be supplied to the polymerization reactor is taken as 100% by weight. In order to improve fuel cost saving properties, it is preferably 50% by weight or less, more preferably 45% by weight or less.

### <Polymerization>

In the method for producing a conjugated diene-based polymer of the present invention, monomers including a compound represented by formula (2), a compound represented by formula (3) and a conjugated diene compound are polymerized using a compound represented by formula (1). The compound represented by formula (1) serves as a polymerization initiator. Usually, polymerization of the monomers is carried out in a solution containing a hydrocarbon as a solvent.

The hydrocarbon is a compound that does not inactivate the compound represented by formula (1), and examples thereof include aliphatic hydrocarbons, aromatic hydrocarbons, and alicyclic hydrocarbons. Examples of the aliphatic hydrocarbon include propane, n-butane, iso-butane, n-pentane, iso-pentane, n-hexane, n-heptane, and n-octane. Examples of the aromatic hydrocarbon include benzene, toluene, xylene, and ethylbenzene. Examples of the alicyclic hydrocarbon include cyclopentane and cyclohexane. The hydrocarbon solvent may be a mixture of various components such as industrial hexane. It is preferably a hydrocarbon having 2 to 12 carbon atoms.

The monomers may be polymerized in the presence of an agent for adjusting the vinyl bonding amount of conjugated diene-derived structural units in a conjugated diene-based polymer, or an agent for adjusting the distribution of conjugated diene-derived structural units and structural units derived from a monomer other than the conjugated diene in a conjugated diene-based polymer chain (hereinafter, collectively referred to as “adjusting agent”). Examples of the agent include ether compounds, tertiary amine compounds, and phosphine compounds. Examples of the ether compound include cyclic ethers such as tetrahydrofuran, tetrahydropyran, and 1,4-dioxane; aliphatic monoethers such as diethyl ether and dibutyl ether; aliphatic diethers such as ethylene glycol dimethyl ether, ethylene glycol diethyl ether, ethylene glycol dibutyl ether, diethylene glycol diethyl ether, and diethylene glycol dibutyl ether; and aromatic ethers such as diphenyl ether and anisole. Examples of the tertiary amine compound include triethylamine, tripropylamine, tributylamine, N,N,N′,N′-tetramethylethylenediamine, N,N-diethylaniline, pyridine, and quinoline.

Examples of the phosphine compound include trimethylphosphine, triethylphosphine, and triphenylphosphine. One or more kinds of them are used.

In the present invention, the compound represented by formula (1) may be supplied to a polymerization reactor before the monomers are supplied to the reaction reactor, or the compound represented by formula (1) may be supplied to the polymerization reactor after the whole amount of the monomers to be used for the polymerization is supplied to the polymerization reactor, or the compound represented by formula (1) may be supplied to the polymerization reactor after a part of the monomers to be used for the polymerization is supplied to the polymerization reactor. The compound represented by formula (1) may be supplied in two or more portions or alternatively may be supplied at once.

In the present invention, the monomers may be supplied in two or more portions or alternatively may be supplied at once. Further, respective monomers may be supplied separately, or simultaneously to the polymerization reactor.

The used amount of the compound represented by formula (1), which is determined appropriately depending upon the molecular weight of the conjugated diene-based polymer to be obtained by polymerization, is usually 0.01 mmol to 15 mmol per 100 g of the monomers to be supplied to the polymerization reactor.

In the present invention, if necessary, other polymerization initiators such as n-butyllithium may be used in combination.

In the case of performing the polymerization of the monomers in a solution containing a hydrocarbon as a solvent, the concentration of the monomers in the solution is usually 1% by weight to 50% by weight, and preferably 5% by weight to 30% by weight.

The polymerization temperature in the present invention, is usually 25° C. to 100° C., preferably 35° C. to 90° C., and more preferably 50° C. to 80° C. The polymerization time is usually 10 minutes to 5 hours.

### <Treatment of Active End of Polymer>

In the method for producing a conjugated diene-based polymer of the present invention, a compound containing a nitrogen atom and/or a silicon atom is reacted to an active end of a polymer produced via polymerization.

Preferable examples of the compound containing a nitrogen atom and/or a silicon atom include compounds containing a nitrogen atom and a carbonyl group.

As the compound containing a nitrogen atom and a carbonyl group, a compound represented by the following formula (4) is preferred,

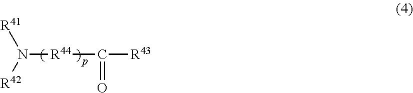

wherein R⁴¹ may be bonded to R⁴² and R⁴¹ may be bonded to R⁴³; R⁴¹ and R⁴² each represent a hydrocarbyl group optionally having a substituent, R⁴³ represents a hydrocarbyl group optionally having a substituent or a hydrogen atom; when R⁴¹ is bonded to R⁴², the group in which R⁴¹ is bonded to R⁴² represents a hydrocarbylene group optionally having a nitrogen atom and/or an oxygen atom as a hetero atom; when R⁴¹ is bonded to R⁴³, the group in which R⁴¹ is bonded to R⁴³ represents a divalent group, R⁴⁴ represents a divalent group, and p represents 0 or 1.

In formula (4), the hydrocarbyl groups optionally having a substituent of R⁴¹, R⁴² and R⁴³ are each a hydrocarbyl group or a substituted hydrocarbyl group. Examples of the substituted hydrocarbyl group include a substituted hydrocarbyl group wherein the substituent is a hydrocarbyloxy group, and a substituted hydrocarbyl group wherein the substituent is a substituted amino group. Examples of the hydrocarbyl group include alkyl groups such as a methyl group, an ethyl group, a n-propyl group, an isopropyl group, and a n-butyl group; alkenyl groups such as a vinyl group, an allyl group, and an isopropenyl group; and aryl groups such as a phenyl group. Examples of the substituted hydrocarbyl group whose substituent is a hydrocarbyloxy group include alkoxyalkyl groups such as a methoxymethyl group, an ethoxymethyl group, and an ethoxyethyl group. Examples of the substituted hydrocarbyl group in which the substituent is a substituted amino group include (dialkylamino)alkyl groups such as a 2-(dimethylamino)ethyl group, a 2-(diethylamino)ethyl group, a 3-(dimethylamino)propyl group, and a 3-(diethylamino)propyl group; (dialkylamino)aryl groups such as a 4-(dimethylamino)phenyl group, a 3-(dimethylamino)phenyl group, a 4-(diethylamino)phenyl group, and a 3-(diethylamino)phenyl group; [(dialkylamino)alkyl]aryl groups such as a 4-[(dimethylamino)methyl]phenyl group and a 4-[2-(dimethylamino)ethyl]phenyl group; cyclic amino group-containing alkyl groups such as a 3-(1-pyrrolidinyl)propyl group, a 3-(1-piperidinyl)propyl group, and a 3-(1-imidazolyl)propyl group; cyclic amino group-containing aryl groups such as a 4-(1-pyrrolidinyl)phenyl group, a 4-(1-piperidinyl)phenyl group, and a 4-(1-imidazolyl)phenyl group; and cyclic amino group-containing alkylaryl groups such as a 4-[2-(1-pyrrolidinyl)ethyl]phenyl group, a 4-[2-(1-piperidinyl)ethyl]phenyl group, and a 4-[2-(1-imidazolyl)ethyl]phenyl group.

Preferable groups of R⁴¹ and R⁴² include a hydrocarbyl group having 1 to 10 carbon atoms. Preferable groups of R⁴³ include a hydrocarbyl group having 1 to 10 carbon atoms, a substituted hydrocarbyl group having 3 to 10 carbon atoms whose substituent is a dialkylamino group, and a hydrogen atom.

In formula (4), the hydrocarbylene group optionally having a nitrogen atom and/or an oxygen atom as a hetero atom which is a group in which R⁴¹ is bonded to R⁴² is a hydrocarbylene group or a hetero atom-containing hydrocarbylene group whose hetero atom is a nitrogen atom and/or an oxygen atom. Examples of the hetero atom-containing hydrocarbylene group whose hetero atom is a nitrogen atom and/or an oxygen atom include a hetero atom-containing hydrocarbylene group whose hetero atom is a nitrogen atom, and a hetero atom-containing hydrocarbylene group whose hetero atom is an oxygen atom. Examples of the hydrocarbylene group include alkylene groups such as a trimethylene group, a tetramethylene group, a pentamethylene group, a hexamethylene group, and a 2,2,4-trimethylhexane-1,6-diyl group; and arylene groups such as a 1,4-phenylene group. Examples of the hetero atom-containing hydrocarbylene group whose hetero atom is a nitrogen atom include a group represented by —CH═N—CH═CH— and a group represented by —CH═N—CH₂—CH₂—. Examples of the hetero atom-containing hydrocarbylene group whose hetero atom is an oxygen atom include a group represented by —(CH₂)ₛ—O—(CH₂)ₜ— (s and t each represent an integer of 1 or more).

Preferable groups in which R⁴¹ is bonded to R⁴² include a hydrocarbylene group having 3 to 10 carbon atoms or a hetero atom-containing hydrocarbylene group having 3 to 10 carbon atoms whose hetero atom is a nitrogen atom.

In formula (4), examples of the divalent group in which R⁴¹ is bonded to R⁴³ and the divalent group of R⁴⁴ include a hydrocarbylene group, a hetero atom-containing hydrocarbylene group whose hetero atom is a nitrogen atom, a hetero atom-containing hydrocarbylene group whose hetero atom is an oxygen atom, a group in which a hydrocarbylene group is bonded to an oxygen atom, and a group in which a hydrocarbylene group is bonded to a group represented by —NR— (R represents a hydrocarbyl group or a hydrogen atom). Examples of the hydrocarbylene group include alkylene groups such as a trimethylene group, a tetramethylene group, a pentamethylene group, a hexamethylene group, and a 2,2,4-trimethylhexane-1,6-diyl group; and arylene groups such as a 1,4-phenylene group. Examples of the hetero atom-containing hydrocarbylene group whose hetero atom is a nitrogen atom include a group represented by —CH═N—CH═CH— and a group represented by —CH═N—CH₂—CH₂—. Examples of the hetero atom-containing hydrocarbylene group whose hetero atom is an oxygen atom include a group represented by —(CH₂)ₛ—O—(CH₂)ₜ— (s and t each represent an integer of 1 or more). Examples of the group in which a hydrocarbylene group is bonded to an oxygen atom include a group represented by —(CH₂)ᵣ—O— (r represents an integer of 1 or more). Examples of the group in which a hydrocarbylene group is bonded to a group represented by —NR—(R represents a hydrocarbyl group or a nitrogen atom) include a group represented by —(CH₂)_{q}—NR′— (R′ represents a hydrocarbyl group having 1 to 6 carbon atoms, or a hydrogen atom, and q represents an integer of 1 or more).

Examples of a preferable divalent group in which R⁴¹ is bonded to R⁴³ include a hydrocarbylene group having 2 to 10 carbon atoms and a group in which a hydrocarbylene group having 1 to carbon atoms is bonded to a group represented by —NR⁴⁰— (R⁴⁰ represents a hydrocarbyl group having 1 to 10 carbon atoms or a hydrogen atom, and the nitrogen atom to which R⁴⁰ is bonded is bonded to the carbon atom of C═O). Examples of a preferable group of R⁴⁴ include a hydrocarbylene group having 1 to 10 carbon atoms and a group in which a hydrocarbylene group having 1 to carbon atoms is bonded to —NH— or an oxygen atom (—NH— or an oxygen atom is bonded to the carbon atom of C═O).

Examples of a preferred compound represented by formula (4) include a compound in which p is 0 and R⁴³ is a hydrocarbyl group optionally having a substituent or a hydrogen atom (a compound represented by formula (4-A)),

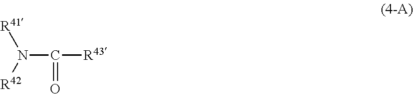

wherein R⁴¹′ may be bonded to R⁴², R⁴¹′ and R⁴² each represent a hydrocarbyl group optionally having a substituent; when R⁴¹′ is bonded to R⁴², the group in which R⁴¹′ is bonded to R⁴² represents a hydrocarbylene group optionally having a nitrogen atom and/or an oxygen atom as a hetero atom, and R⁴³′ represents a hydrocarbyl group optionally having a substituent or a hydrogen atom.

In formula (4-A), examples of the hydrocarbyl groups optionally having a substituent of R⁴¹′, R⁴² and R⁴³′ include the groups provided as examples of the hydrocarbyl groups optionally having a substituent of R⁴¹, R⁴² and R⁴³ in formula (4). Examples of the hydrocarbylene group optionally having a nitrogen atom and/or an oxygen atom as a hetero atom and being a group in which R⁴¹′ is bonded to R⁴² include the groups provided as examples of the hydrocarbylene group optionally having a nitrogen atom and/or an oxygen atom as a hetero atom and being a group in which R⁴¹ is bonded to R⁴² in formula (4).

In formula (4-A), R⁴¹′ and R⁴² are each preferably a hydrocarbyl group having 1 to 10 carbon atoms, or R⁴¹′ is bonded to R⁴² and the group in which R⁴¹′ is bonded to R⁴² is a hydrocarbylene group having 3 to 10 carbon atoms or a hetero atom-containing hydrocarbylene group having 3 to 10 carbon atoms whose hetero atom is a nitrogen atom. More preferably, R⁴¹′ and R⁴² are each an alkyl group having 1 to 10 carbon atoms or an aryl group having 6 to 10 carbon atoms, or the group in which R⁴¹′ is bonded to R⁴² is an alkylene group having 3 to 10 carbon atoms, a group represented by —CH═N—CH═CH—, or a group represented by —CH═N—CH₂—CH₂—. Even more preferred is an alkyl group having 1 to 6 carbon atoms. Particularly preferred is a methyl group or an ethyl group.

In formula (4-A), R⁴³′ is preferably a hydrocarbyl group or a hydrogen atom, more preferably a hydrocarbyl group having 1 to 10 carbon atoms or a hydrogen atom, even more preferably an alkyl group having 1 to 6 carbon atoms or a hydrogen atom, and particularly preferably a hydrogen atom, a methyl group or an ethyl group.

Examples of a preferable compound represented by formula (4-A) include a compound in which R⁴¹′ and R⁴² are each a hydrocarbyl groups having 1 to 10 carbon atoms and R⁴³′ is a hydrocarbyl group having 1 to 10 carbon atoms or a hydrogen atom.

Examples of a group in which R⁴³′ is a hydrocarbyl group among the compounds represented by formula (4-A) include N,N-dihydrocarbylacetamides such as N,N-dimethylacetamide, N,N-diethylacetamide, and N-methyl-N-ethylacetamide; N,N-dihydrocarbylacrylamides such as N-dimethylacrylamide, N,N-diethylacrylamide, and N-methyl-N-ethylacrylamide; and N,N-dihydrocarbylmethacrylamides such as N,N-dimethylmethacrylamide, N,N-diethylmethacrylamide, and N-methyl-N-ethylmethacrylamide.

Examples of a group in which R⁴³′ is a hydrogen atom among the compounds represented by formula (4-A) include N,N-dihydrocarbylformamides such as N,N-dimethylformamide, N,N-diethylformamide, and N-methyl-N-ethylformamide.

Examples of a preferred compound represented by formula (4) include a compound in which p is 0 and R⁴¹ is bonded to R⁴³ (a compound represented by formula (4-B)),

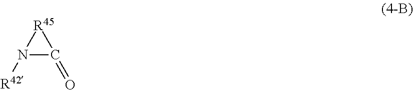

in formula (4-B), R⁴²′ represents a hydrocarbyl group optionally having a substituent, R⁴⁵ represents a group in which a hydrocarbylene group is bonded to a group represented by —NR⁴⁶— or a hydrocarbylene group, wherein R⁴⁶ represents a hydrocarbyl group or a hydrogen atom, and the nitrogen atom to which R⁴⁶ is bonded is bonded to the carbon atom of C═O.

In formula (4-B), examples of the hydrocarbyl group optionally having a substituent of R⁴²′ include the groups provided as examples of the hydrocarbyl groups optionally having a substituent of R⁴¹, R⁴² and R⁴³.

In formula (4-B), examples of the hydrocarbylene group of R⁴⁵ include alkylene groups such as a trimethylene group, a tetramethylene group, a pentamethylene group, a hexamethylene group, and a 2,2,4-trimethylhexane-1,6-diyl group; and arylene groups such as a 1,4-phenylene group. Examples of the group in which a hydrocarbylene group is bonded to a group represented by —NR⁴⁶— (R⁴⁶ represents a hydrocarbyl group or a hydrogen atom) include a group represented by —(CH₂)ᵥ—NR⁴⁶— (R⁴⁶ represents a hydrocarbyl group or a hydrogen atom, and v represents an integer of 1 or more).

In formula (4-B), R⁴²′ is preferably a hydrocarbyl group having 1 to 10 carbon atoms, more preferably an alkyl group having 1 to 10 carbon atoms or an aryl group having 6 to 10 carbon atoms, even more preferably an alkyl group having 1 to 6 carbon atoms or a phenyl group, and particularly preferably a methyl group, an ethyl group, or a phenyl group.

In formula (4-B), R⁴⁶ is preferably a hydrocarbylene group having 2 to 10 carbon atoms, or a group in which a hydrocarbylene group having 1 to 10 carbon atoms is bonded to a group represented by —NR⁴⁶′— (R⁴⁶′ represents a hydrocarbyl group having 1 to 10 carbon atoms or a hydrogen atom), more preferably an alkylene group having 3 to 6 carbon atoms or a group represented by —(CH₂)—NR⁴⁶″— (R⁴⁶″ represents a hydrocarbyl group having 1 to 10 carbon atoms, and w represents an integer of 2 to 5), and even more preferably a trimethylene group, a tetramethylene group, a pentamethylene group, or a group represented by —(CH₂)₂—N(CH₃)—.

Among the compounds represented by formula (4-B), examples of a compound in which R⁴⁵ is a hydrocarbylene group include N-hydrocarbyl-2-azetidinones such as N-methyl-2-azetidinone and N-phenyl-2-azetidinone; N-hydrocarbyl-2-pyrrolidones such as N-methyl-2-pyrrolidone, N-vinyl-2-pyrrolidone, N-phenyl-2-pyrrolidone, N-tert-butyl-2-pyrrolidone, and N-methyl-5-methyl-2-pyrrolidone; N-hydrocarbyl-2-piperidones such as N-methyl-2-piperidone, N-vinyl-2-piperidone, and N-phenyl-2-piperidone; N-hydrocarbyl-6-haxanelactams such as N-methyl-6-haxanelactam and N-phenyl-6-haxanelactam; and N-hydrocarbyl-12-dodecanelactams such as N-methyl-12-dodecanelactam and N-vinyl-12-dodecanelactam. Preferred is a compound in which R⁴⁶ is an alkylene group having 3 to 6 carbon atoms and R⁴²′ is an alkyl group having 1 to 6 carbon atoms or a phenyl group, more preferred is a compound in which R⁴⁵ is a trimethylene group, a tetramethylene group, or a pentamethylene group and R⁴²′ is a methyl group, an ethyl group, or a phenyl group, and even more preferred is N-phenyl-2-pyrrolidone or N-methyl-6-hexanelactam.

Among the compounds represented by formula (4-B), examples of a compound in which the group in which a hydrocarbylene group is bonded to a group represented by —NR⁴⁶— (R⁴⁶ represents a hydrocarbyl group or a hydrogen atom) is R⁴⁵ include 1,3-dihydrocarbyl-2-imidazolidinones such as 1,3-dimethyl-2-imidazolidinone, 1,3-diethyl-2-imidazolidinone, 1,3-divinyl-2-imidazolidinone, and 1-methyl-3-ethyl-2-imidazolidinone. Preferred is a compound wherein R⁴⁵ is a group represented by —(CH₂)_{w}—NR⁴⁶″— (R⁴⁶″ represents a hydrocarbyl group having 1 to 10 carbon atoms, and w is an integer of 2 to 5), and R⁴²′ is an alkyl group having 1 to 6 carbon atoms or a phenyl group, more preferred is a group wherein R⁴⁵ is a group represented by —(CH₂)₂—N(CH₃)— and R⁴²′ is a methyl group, an ethyl group or a phenyl group, and even more preferred is 1,3-dimethyl-2-imidazolidinone.

Examples of a preferable compound represented by formula (4) include a compound in which p is 1 and R⁴⁴ is a hydrocarbylene group (a compound represented by the following formula (4-C)),

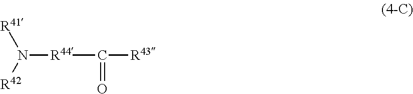

wherein R⁴¹′ may be bonded to R⁴², R⁴¹′ and R⁴² each represent a hydrocarbyl group optionally having a substituent; when R⁴¹′ is bonded to R⁴², the group in which R⁴¹′ is bonded to R⁴² represents a hydrocarbylene group optionally having a nitrogen atom and/or an oxygen atom as a hetero atom, R⁴³″ represents a hydrocarbyl group optionally having a substituent or a hydrogen atom, and R⁴⁴′ represents a hydrocarbylene group.

In formula (4-C), examples of the hydrocarbyl groups optionally having a substituent of R⁴¹′, R⁴² and R⁴³″ include the groups provided as examples of the hydrocarbyl groups optionally having a substituent of R⁴¹, R⁴² and R⁴³ in formula (4). Examples of the hydrocarbylene group optionally having a nitrogen atom and/or an oxygen atom as a hetero atom and being a group in which R⁴¹′ is bonded to R⁴² include the groups provided as examples of the hydrocarbylene group optionally having a nitrogen atom and/or an oxygen atom as a hetero atom and being a group in which R⁴¹ is bonded to R⁴² in formula (4). Examples of the hydrocarbylene group of R⁴⁴′ include the groups provided as examples of the hydrocarbylene group of R⁴⁴ in formula (4).

In formula (4-C), preferably, R⁴¹′ and R⁴² are each a hydrocarbyl group having 1 to 10 carbon atoms, or R⁴¹′ is bonded to R⁴² and the group in which R⁴¹′ is bonded to R⁴² is a hydrocarbylene group having 3 to 10 carbon atoms or a hetero atom-containing hydrocarbylene group having 3 to 10 carbon atoms whose hetero atom is a nitrogen atom. More preferably, R⁴¹′ and R⁴² are each an alkyl group having 1 to 10 carbon atoms or an aryl group having 6 to 10 carbon atoms, or the group in which R⁴¹′ is bonded to R⁴² is an alkylene group having 3 to 10 carbon atoms, a group represented by —CH═N—CH═CH—, a group represented by —CH═N—CH₂—CH₂—, or a group represented by —(CH₂)₂—O—(CH₂)₂—. Even more preferably, R⁴¹′ and R⁴² are each an alkyl group having 1 to 6 carbon atoms. Particularly preferably, R⁴¹′ and R⁴² are each a methyl group or an ethyl group.

In formula (4-C), R⁴³″ is preferably a hydrocarbyl group having 1 to 10 carbon atoms or a substituted hydrocarbyl group having 3 to 10 carbon atoms whose substituent is a dialkylamino group, more preferably an alkyl group having 1 to 6 carbon atoms, an aryl group having 6 to 10 carbon atoms, a dialkylaminoalkyl group having 3 to 6 carbon atoms or a dialkylaminoaryl group having 8 to 10 carbon atoms, even more preferably a methyl group, an ethyl group, a dialkylaminomethyl group having 3 to 6 carbon atoms, a dialkylaminoethyl group having 4 to 6 carbon atoms, a phenyl group, or a dialkylaminophenyl group having 8 to 10 carbon atoms, and particularly preferably a phenyl group or a dialkylaminophenyl having 8 to 10 carbon atoms.

In formula (4-C), R⁴⁴′ is preferably a hydrocarbylene group having 1 to 10 carbon atoms, more preferably an alkylene group having 1 to 10 carbon atoms or an arylene group having 6 to 10 carbon atoms, even more preferably an alkylene group having 1 to 6 carbon atoms or a phenylene group, further preferably a phenylene group, and particularly preferably a 1,4-phenylene group.

Among the compounds represented by formula (4-C), examples of a compound in which R⁴⁴′ is an arylene group and R⁴³″ is an alkyl group include 4-(N,N-dihydrocarbylamino)acetophenones such as 4-(N,N-dimethylamino)acetophenone, 4-(N-methyl-N-ethylamino)acetophenone, and 4-(N,N-diethylamino)acetophenone; and 4-cyclic aminoacetophenone compounds such as 4′-(imidazol-1-yl)acetophenone. Among them, a 4-cyclic aminoacetophenone compound is preferred, and 4′-(imidazol-1-yl)acetophenone is more preferred.

Among the compounds represented by formula (4-C), examples of a compound in which R⁴⁴′ is an arylene group and R⁴³″ is an aryl group or a substituted aryl group include bis(dihydrocarbylaminoalkyl)ketones such as 1,7-bis(methylethylamino)-4-heptanone and 1,3-bis(diphenylamino)-2-propanone; 4-(dihydrocarbylamino)benzophenones such as 4-N,N-dimethylaminobenzophenone, 4-N,N-diethylaminobenzophenone, 4-N,N-di-t-butylaminobenzophenone, and 4-N,N-diphenylaminobenzophenone; and 4,4′-bis(dihydrocarbylamino)benzophenones such as 4,4′-bis(dimethylamino)benzophenone, 4,4′-bis(diethylamino)benzophenone, and 4,4′-bis(diphenylamino)benzophenone. Among them, a compound in which R⁴¹′ and R⁴² are each an alkyl group having 1 to 6 carbon atoms, R⁴⁴′ is a phenylene group, and R⁴³″ is a phenyl group or a dialkylaminophenyl group having 8 to 10 carbon atoms is preferred, and 4-N,N-dimethylaminobenzophenone, 4-N,N-diethylaminobenzophenone, 4,4′-bis(dimethylamino)benzophenone, and 4,4′-bis(diethylamino)benzophenone are more preferred.

Examples of a preferable compound represented by formula (4) include a compound in which p is 1 and R⁴⁴ is a group in which a hydrocarbylene group is bonded to an oxygen atom or a group in which a hydrocarbylene group is bonded to a group represented by —NR⁴⁷— (R⁴⁷ represents a hydrocarbyl group or a hydrogen atom) (a compound represented by the following formula (4-D)),

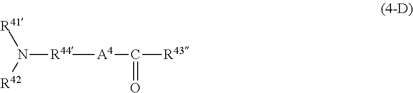

wherein R⁴¹′ may be bonded to R⁴², R⁴¹′ and R⁴² each represent a hydrocarbyl group optionally having a substituent; when R⁴¹′ is bonded to R⁴², the group in which R⁴¹′ is bonded to R⁴² represents a hydrocarbylene group optionally having a nitrogen atom and/or an oxygen atom as a hetero atom, and R⁴³″represents a hydrocarbyl group optionally having a substituent, R⁴⁴′ represents a hydrocarbylene group, A⁴ represents an oxygen atom or a group represented by —NR⁴⁷, wherein R⁴⁷ represents a hydrocarbyl group or a hydrogen atom.

In formula (4-D), examples of the hydrocarbyl groups optionally having a substituent of R⁴¹′, R⁴² and R⁴³″ include the groups provided as examples of the hydrocarbyl groups optionally having a substituent of R⁴¹, R⁴² and R⁴³ in formula (4). Examples of the hydrocarbylene group optionally having a nitrogen atom and/or an oxygen atom as a hetero atom and being a group in which R⁴¹′ is bonded to R⁴² include the groups provided as examples of the hydrocarbylene group optionally having a nitrogen atom and/or an oxygen atom as a hetero atom and being a group in which R⁴¹ is bonded to R⁴² in formula (4).

In formula (4-D), preferably, R⁴¹′ and R⁴² are each a hydrocarbyl group having 1 to 10 carbon atoms, or R⁴¹′ is bonded to R⁴² and the group in which R⁴¹′ is bonded to R⁴² is a hydrocarbylene group having 3 to 10 carbon atoms or a hetero atom-containing hydrocarbylene group having 3 to 10 carbon atoms whose hetero atom is a nitrogen atom. More preferably, R⁴¹′ and R⁴² are each an alkyl group having 1 to 10 carbon atoms or an aryl group having 6 to 10 carbon atoms, or the group in which R⁴¹′ is bonded to R⁴² is an alkylene group having 3 to 10 carbon atoms, a group represented by —CH═N—CH═CH—, a group represented by —CH═N—CH₂—CH₂—, or a group represented by —(CH₂)₂—O—(CH₂)₂—. R⁴¹′ and R⁴² are each further preferably an alkyl group having 1 to 6 carbon atoms, and particularly preferred a methyl group or an ethyl group.

In formula (4-D), R⁴³″ is preferably a hydrocarbyl group having 1 to 10 carbon atoms, more preferably an alkenyl group having 2 to 5 carbon atoms, even more preferably a vinyl group or an isopropenyl group, and particularly preferably a vinyl group.

In formula (4-D), examples of the hydrocarbylene group of R⁴⁴′ include alkylene groups such as a trimethylene group, a tetramethylene group, a pentamethylene group, a hexamethylene group, and a 2,2,4-trimethylhexane-1,6-diyl group; and arylene groups such as a 1,4-phenylene group.

In formula (4-D), R⁴⁴′ is preferably a hydrocarbylene group having 1 to 10 carbon atoms, more preferably an alkylene group having 1 to 6 carbon atoms, even more preferably an ethylene group or a trimethylene group, and particularly preferably a trimethylene group.

In formula (4-D), A⁴ is preferably an oxygen atom or a group represented by —NR⁴⁷— (R⁴⁷ represents a hydrocarbyl group having 1 to 5 carbon atoms or a hydrogen atom), more preferably an oxygen atom or a group represented by —NH—, and even more preferably a group represented by —NH—.

Examples of a preferable compound represented by formula (4-D) include a compound in which R⁴¹′, R⁴² and R⁴³″ are each a hydrocarbyl groups having 1 to 10 carbon atoms, R⁴⁴′ is a hydrocarbylene group having 1 to 10 carbon atoms, and A⁴ is an oxygen atom or a group represented by —NH—.

Among the compounds represented by formula (4-D), examples of the compound wherein A⁴ is an oxygen atom include 2-(dihydrocarbylamino)ethyl acrylates such as 2-(dimethylamino)ethyl acrylate and 2-(diethylamino)ethyl acrylate; 3-(dihydrocarbylamino)propyl acrylates such as 3-(dimethylamino)propyl acrylate; 2-(dihydrocarbylamino)ethyl methacrylates such as 2-(dimethylamino)ethyl methacrylate and 2-(diethylamino)ethyl methacrylate; 3-(dihydrocarbylamino)propyl methacrylates such as 3-(dimethylamino)propyl methacrylate. A compound wherein A⁴ is an oxygen atom, R⁴¹ and R⁴² are each an alkyl group having 1 to 6 carbon atoms, R⁴³″ is a vinyl group or an isopropenyl group, and R⁴⁴′ is an ethylene group or a trimethylene group is preferred, and a compound wherein A⁴ is an oxygen atom, R⁴¹ and R⁴² are each a methyl group or an ethyl group, R⁴³″ is a vinyl group, and R⁴⁴′ is a trimethylene group is more preferred.

Among the compounds represented by formula (4-D), examples of a compound in which A⁴ is a group represented by —NR⁴⁷— (R⁴⁷ represents a hydrocarbyl group or a hydrogen atom) include:

N-(2-dihydrocarbylaminoethyl)acrylamides such as N-(2-dimethylaminoethyl)acrylamide and N-(2-diethylaminoethyl)acrylamide; N-(3-dihydrocarbylaminopropyl)acrylamides such as N-(3-dimethylaminopropyl)acrylamide and N-(3-diethylaminopropyl)acrylamide; N-(4-dihydrocarbylaminobutyl)acrylamides such as N-(4-dimethylaminobutyl)acrylamide and N-(4-diethylaminobutyl)acrylamide; N-(2-dihydrocarbylaminoethyl)methacrylamides such as N-(2-dimethylaminoethyl)methacrylamide and N-(2-diethylaminoethyl)methacrylamide; N-(3-dihydrocarbylaminopropyl)methacrylamides such as N-(3-dimethylaminopropyl)methacrylamide and N-(3-diethylaminopropyl)methacrylamide; N-(4-dihydrocarbylaminobutyl)methacrylamides such as N-(4-dimethylaminobutyl)methacrylamide and N-(4-diethylaminobutyl)methacrylamide. Among them, a compound in which A⁴ is a group represented by —NH—, R⁴¹′ and R⁴² are each an alkyl group having 1 to 6 carbon atoms, R⁴³″ is a vinyl group or an isopropenyl group, and R⁴⁴′ is an ethylene group or a trimethylene group is preferred, and a compound in which A⁴ is a group represented by —NH—, R⁴¹′ and R⁴² are each a methyl group or a ethyl group, R⁴³″ is a vinyl group, and R⁴⁴′ is a trimethylene group is more preferred.

In addition to those described above, examples of a preferable compound among compounds containing a nitrogen atom and/or a silicon atom include a compound containing an alkoxysilyl group.

A compound containing a nitrogen atom and an alkoxysilyl group is preferred as the compound containing an alkoxysilyl group, and examples of the compound include compounds represented by the following formula (5),

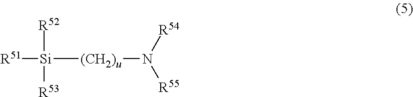

in formula (5), R⁵⁴ may be bonded to R⁵⁵, R⁵¹, R⁵² and R⁵³ each represent a hydrocarbyl group or a hydrocarbyloxy group, at least one of R⁵¹, R⁵² and R⁵³ is a hydrocarbyloxy group; R⁵⁴ and R⁵⁵ each represent a hydrocarbyl group optionally having a substituent or a trihydrocarbylsilyl group, or when R⁵⁴ is bonded to R⁵⁵, the group in which R⁵⁴ is bonded to R⁵⁵ represents a hydrocarbylene group optionally having a nitrogen atom and/or an oxygen atom as a hetero atom, a group represented by —Si(R⁵⁶)₂—(CH₂)ₓ—Si(R⁵⁶)₂— (R⁵⁶ represents a hydrocarbyl group and x represents an integer of 1 to 10.) and having 5 to 20 carbon atoms, or a group represented by —Si(R⁵⁷)₂—(CH₂)_{y}— (R⁵⁷ represents a hydrocarbyl group and y represents an integer of 2 to 11) and having 4 to 20 carbon atoms and u represents an integer of 1 to 5.

In the above formula (5), examples of the hydrocarbyl groups of R⁵¹, R⁵² and R⁵³ include alkyl groups such as a methyl group, an ethyl group, a n-propyl group, an isopropyl group, and a n-butyl group; alkenyl groups such as a vinyl group, an allyl group, and an isopropenyl group; and aryl groups such as a phenyl group; alkyl groups are preferred; alkyl groups having 1 to 4 carbon atoms are more preferred, and a methyl group or an ethyl group is even more preferred.

Examples of the hydrocarbyloxy groups of R⁵¹, R⁵² and R⁵³ include alkoxy groups such as a methoxy group, an ethoxy group, a n-propoxy group, an isopropoxy group, a n-butoxy group, a sec-butoxy group, and a tert-butoxy group; and aryloxy groups such as a phenoxy group and a benzyloxy group. Preferred is an alkoxy group, more preferred is an alkoxy group having 1 to 4 carbon atoms, and even more preferred is a methoxy group or an ethoxy group.

In the above formula (5), at least one of R⁵¹, R⁵² and R⁵³ is a hydrocarbyloxy group. Preferably, at least two of R⁵¹, R⁵² and R⁵³ are hydrocarbyloxy groups, and more preferably, three of R⁵¹, R⁵² and R⁵³ are hydrocarbyloxy groups.

In the above formula (5), the hydrocarbyl groups optionally having a substituent of R⁵⁴ and R⁵⁵ are each a hydrocarbyl group or a substituted hydrocarbyl group.

Examples of the hydrocarbyl groups of R⁵⁴ and R⁵⁵ include alkyl groups such as a methyl group, an ethyl group, a n-propyl group, an isopropyl group, and a n-butyl group; alkenyl groups such as a vinyl group, an allyl group, and an isopropenyl group; and aryl groups such as a phenyl group; alkyl groups are preferred, alkyl groups having 1 to 4 carbon atoms are more preferred, and a methyl group or an ethyl group is even more preferred.

Examples of the substituted hydrocarbyl groups of R⁵⁴ and R⁵⁵ include oxacycloalkyl groups such as an oxiranyl group and a tetrahydrofuranyl group, and a tetrahydrofuranyl group is preferred.

Herein, the oxacycloalkyl group represents a group in which CH₂ on an alicycle of a cycloalkyl group is replaced with an oxygen atom.

Examples of the trihydrocarbylsilyl groups of R⁵⁴ and R⁵⁵ include a trimethylsilyl group and a tert-butyl-dimethylsilyl group, and a trimethylsilyl group is preferred.

The hydrocarbylene group optionally having a nitrogen atom and/or an oxygen atom as a hetero atom in the group in which R⁵⁴ is bonded to R⁵⁵ is a hydrocarbylene group or a hetero atom-containing hydrocarbylene group having a nitrogen atom and/or an oxygen atom as a hetero atom.

Examples of the hydrocarbylene group include an alkylene group such as a tetramethylene group, a pentamethylene group, a hexamethylene group, and a 2,2,4-trimethylhexane-1,6-diyl group; among others, an alkylene group having 4 to 7 carbon atoms is preferred, and a pentamethylene group or a hexamethylene group is particularly preferred.

Examples of the hetero atom-containing hydrocarbylene group having a nitrogen atom and/or an oxygen atom as a hetero atom include a group represented by —CH═N—CH═CH— or a hetero atom-containing hydrocarbylene group whose hetero atom is a nitrogen atom such as a group represented by —CH═N—CH₂—CH₂—; and a hetero atom-containing hydrocarbylene group whose hetero atom is an oxygen atom such as a group represented by —CH₂—CH₂—O—CH₂—CH₂—.

In the group in which R⁵⁴ is bonded to R⁵⁵, examples of the group represented by —Si(R⁵⁶)₂—(CH₂)ₓ—Si(R⁵⁶)₂— and having 5 to 20 carbon atoms (R⁵⁶ represents a hydrocarbyl group and x represents an integer of 1 to 10) include a group represented by —Si(CH₃)₂—CH₂—CH₂—Si(CH₃)₂—. Examples of the group represented by —Si(R⁵⁷)₂—(CH₂)_{y}— and having 4 to 20 carbon atoms (R⁵⁷ represents a hydrocarbyl group and y represents an integer of 2 to 11) include a group represented by —Si (CH₃)₂—CH₂—CH₂—CH₂—.

In the above formula (5), u represents an integer of 1 to 5, preferably is an integer of 2 to 4, and more preferably is 3.

Examples of the compound represented by formula (5) include [(dialkylamino)alkyl]alkoxysilane compounds such as [3-(dimethylamino)propyl]triethoxysilane, [3-(dimethylamino)propyl]trimethoxysilane, [3-(diethylamino)propyl]triethoxysilane, [3-(diethylamino)propyl]trimethoxysilane, [3-(dimethylamino)propyl]methyldiethoxysilane, [2-(dimethylamino)ethyl]triethoxysilane, and [2-(dimethylamino)ethyl]trimethoxysilane; cyclic aminoalkylalkoxysilane compounds such as (1-hexamethyleneiminomethyl)trimethoxysilane, [3-(1-hexamethyleneimino)propyl]triethoxysilane, 1-(3-triethoxysilylpropyl)-4,5-dihydroimidazole, and 1-(3-trimethoxysilylpropyl)imidazole; {[bis(3-tetrahydrofuranyl)amino]alkyl}alkoxysilane compounds such as {3-[bis(3-tetrahydrofuranyl)amino]propyl}trimethoxysilane and {3-[bis(3-tetrahydrofuranyl)amino]propyl}triethoxysilane; and [bis(trialkylsilyl)aminoalkyl]alkylalkoxysilane compounds such as {3-[bis(trimethylsilyl)amino]propyl}methyldimethoxysilane and {3-[bis(trimethylsilyl)amino]propyl}methyldiethoxysilane.

Preferred as the compound represented by formula (5) is a compound wherein R⁵¹ is an alkyl group having 1 to 4 carbon atoms, R⁵² and R⁵³ are each an alkoxy group having 1 to 4 carbon atoms, R⁵⁴ and R⁵⁵ are each an alkyl group having 1 to 4 carbon atoms, and u is an integer of 2 to 4, and more preferred is a compound wherein R⁵¹ is a methyl group or an ethyl group, R⁵² and R⁵³ are each a methoxy group or an ethoxy group, R⁵⁴ and R⁵⁵ are each a methyl group or an ethyl group, and u is 3.

Besides the aforementioned compounds containing a nitrogen atom and an alkoxysilyl group, examples of the compound containing an alkoxysilyl group include:

(glycidoxyalkyl)alkylalkoxysilane compounds such as 2-glycidoxyethyltrimethoxysilane, 2-glycidoxyethyltriethoxysilane, (2-glycidoxyethyl)methyldimethoxysilane, 3-glycidoxypropyltrimethoxysilane, 3-glycidoxypropyltriethoxysilane, and (3-glycidoxypropyl)methyldimethoxysilane; (3,4-epoxycyclohexyl)alkylalkoxysilane compounds such as 2-(3,4-epoxycyclohexyl)ethyltrimethoxysilane and 2-(3,4-epoxycyclohexyl)ethyltriethoxysilane; [(3,4-epoxycyclohexyl)alkyl]alkylalkoxysilane compounds such as [2-(3,4-epoxycyclohexyl)ethyl]methyldimethoxysilane; alkoxysilylalkylsuccinic acid anhydrides such as 3-trimethoxysilylpropylsuccinic acid anhydride and 3-triethoxysilylpropylsuccinic acid anhydride; and (methacryloyloxyalkyl)alkoxysilane compounds such as 3-methacryloyloxypropyltrimethoxysilane and 3-methacryloyloxypropyltriethoxysilane.

The compound containing an alkoxysilyl group may contain a nitrogen atom and a group represented by >C═O. Examples of a compound containing an alkoxysilyl group and also containing a nitrogen atom and a group represented by >C═O include a tris[(alkoxysilyl)alkyl]isocyanurate compound such as tris[3-(trimethoxysilyl)propyl]isocyanurate, tris[3-(triethoxysilyl)propyl]isocyanurate, tris[3-(tripropoxysilyl)propyl]isocyanurate, and tris[3-(tributoxysilyl)propyl]isocyanurate. Among them, tris[3-(trialkoxysilyl)propyl]isocyanurate is preferable, tris[3-(trialkoxysilyl)propyl]isocyanurate in which the alkoxy group is an alkoxy group having 1 to 4 carbon atoms is more preferable, and tris[3-(trimethoxysilyl)propyl]isocyanurate is further preferable.

The reaction of an active end of a polymer produced by polymerizing monomers (an alkali metal derived from the compound represented by formula (1) is believed to have been bonded to the active end of the polymer), the compound containing a nitrogen atom and/or a silicon atom and a conjugated diene polymer is carried out by adding the compound containing a nitrogen atom and/or a silicon atom to a solvent, and mixing the polymer and the compound containing a nitrogen atom and/or a silicon atom in the solution. The amount of the compound containing a nitrogen atom and/or silicon atom to be added to the solvent is usually 0.1 mol to 3 mol, preferably 0.5 mol to 2 mol, and more preferably 0.7 mol to 1.5 mol, per 1 mol of the alkali metal derived from the compound represented by formula (1).

The temperature at which the polymer and the compound containing a nitrogen atom and/or a silicon atom are mixed is 25° C. to 100° C., preferably 35° C. to 90° C., and more preferably 50° C. to 80° C. The mixing time is 60 seconds to 5 hours, and preferably 5 minutes to 1 hour.

### <Coupling>

In the production method of the present invention, a coupling agent may be added to a solvent between the initiation of the polymerization of the monomers and the collection of a polymer described below. Examples of such a coupling agent include a compound represented by the following formula (6),

R^{61a}M¹L₄₋ₐ (6)

wherein R⁶¹ represents an alkyl group, an alkenyl group, a cycloalkenyl group or an aryl group, M¹ represents a silicon atom or a tin atom, L represents a halogen atom or a hydrocarbyloxy group, and a represents an integer of 0 to 2.

Examples of the coupling agent represented by formula (6) include silicon tetrachloride, methyltrichlorosilane, dimethyldichlorosilane, trimethylchlorosilane, tin tetrachloride, methyltrichlorotin, dimethyldichlorotin, trimethylchlorotin, tetramethoxysilane, methyltrimethoxysilane, dimethoxydimethylsilane, methyltriethoxysilane, ethyltrimethoxysilane, dimethoxydiethylsilane, diethoxydimethylsilane, tetraethoxysilane, ethyltriethoxysilane, and diethoxydiethylsilane.

The amount of the coupling agent added is preferably 0.03 mol or more in order to improve the processability of the conjugated diene-based polymer, and more preferably 0.05 mol or more per 1 mol of the alkali metal derived from the alkali metal catalyst represented by formula (1). Moreover, in order to improve fuel cost saving properties, the amount of the coupling agent added is preferably 0.4 mol or less, and more preferably 0.3 mol or less per 1 mol of the alkali metal derived from the alkali metal catalyst represented by formula (1).

### <Collection of Polymer>

In the production method of the present invention, an unreacted active end of a polymer may be treated with an alcohol such as methanol, isopropanol and 1-butanol before collecting the polymer from a solvent in which the polymer has been dissolved.

A publicly known method can be used as a method of collecting a conjugated diene-based polymer from a solvent in which the polymer has been dissolved, and examples thereof include (A) a method of adding a coagulant to the solvent containing the conjugated diene-based polymer and (B) a method of adding steam to the solvent containing the conjugated diene-based polymer. The collected conjugated diene-based polymer may be dried with a known dryer such as a band dryer or an extrusion-type dryer.

### [Conjugated Diene-Based Polymer]

The conjugated-diene-based polymer of the present invention is a conjugated diene-based polymer produced by the aforementioned process.

The Mooney viscosity (ML₁₊₄) of the conjugated diene-based polymer of the present invention is preferably 10 or more in order to increase tensile strength at break, and more preferably 20 or more. Moreover, in order to enhance processability, the Mooney viscosity is preferably 200 or less, and more preferably 150 or less. The Mooney viscosity (ML₁₊₄) is measured at 100° C. according to JIS K6300 (1994).

The content of the structural units derived from the compound represented by formula (2) in the conjugated diene-based polymer is preferably 0.01% by weight or more in order to improve fuel cost saving properties, more preferably 0.02% by weight or more, and even more preferably 0.15% by weight or more per 100% by weight of the conjugated diene-based polymer. In order to enhance tensile strength at break, that content is preferably 20% by weight or less, more preferably 6% by weight or less, and even more preferably 3% by weight or less.

The content of the structural units derived from the compound represented by formula (3) in the conjugated diene-based polymer is preferably 0.01% by weight or more in order to improve fuel cost saving properties, more preferably 0.02% by weight or more, and even more preferably 0.05% by weight or more per 100% by weight of the conjugated diene-based polymer. In order to enhance tensile strength at break, that content is preferably 20% by weight or less, more preferably 2% by weight or less, and even more preferably 1% by weight or less.

The total content of the structural units derived from the compound represented by formula (2) and the structural units derived from the compound represented by formula (3) in the conjugated diene-based polymer is preferably 0.02% by weight or more in order to improve fuel cost saving properties, more preferably 0.04% by weight, and even more preferably 0.2% by weight or more per 100% by weight of the conjugated diene-based polymer. Moreover, it is preferably 25% by weight or less, more preferably 7% by weight or less, and even more preferably 3.5% by weight or less.

The weight ratio of the content of the structural units derived from the compound represented by formula (3) and the content of the structural units derived from the compound represented by formula (2) in the conjugated diene-based polymer (the content of the structural units derived from the compound represented by formula (2)/the content of the structural units derived from the compound represented by formula (3)) is preferably 1/10 or more in order to improve fuel cost saving properties, more preferably 1/1 or more, and even more preferably 3/1 or more. Moreover, it is preferably 10/1 or less, more preferably 7/1 or less, and even more preferably 5/1 or less.

That is, the weight ratio of the content of the structural units derived from the compound represented by formula (2) to the content of the structural units derived from the compound represented by formula (3) in the conjugated diene-based polymer is preferably 0.1 or more, more preferably 1 or more, and even more preferably 3 or more. Moreover, it is preferably 10 or less, more preferably 7 or less, and even more preferably 5 or less.

The content of the structural units derived from the conjugated diene compound in the conjugated diene-based polymer is preferably 99.98% by weight or less, more preferably 90% by weight or less, and even more preferably 85% by weight or less where the amount of the conjugated diene-based polymer is taken as 100% by weight. In order to improve fuel cost saving properties, it is preferably 50% by weight or more, and more preferably 55% by weight or more.

The content of the structural units derived from the aromatic vinyl compound in the conjugated diene-based polymer is 0% by weight or more, preferably 9% by weight or more, and even more preferably 14% by weight or more where the content of the conjugated diene-based polymer is taken as 100% by weight. In order to improve fuel cost saving properties, it is preferably 50% by weight or less, more preferably 45% by weight or less.

The vinyl bonding amount in the conjugated diene-based polymer of the present invention is preferably 80 mol % or less per 100 mol % of the content of the structural units derived from the conjugated diene compound in order to improve fuel cost saving properties, and more preferably 70 mol % or less. In order to enhance gripping properties, the vinyl bonding amount is preferably 10 mol % or more, more preferably 15 mol % or more, even more preferably 20 mol % or more, and particularly preferably 40 mol % or more. The vinyl bonding amount is obtained from the absorption intensity around 910 cm¹, which is the absorption peak of a vinyl group, by an infrared spectrometric method.

### [Conjugated Diene-Based Polymer Composition]

The conjugated diene-based polymer of the present invention can be used as a conjugated diene-based polymer composition by incorporating a polymer component other than that polymer and additives with that polymer.

Examples of polymeric components other than the polymer include a styrene-butadiene copolymer rubber, a polybutadiene rubber, a butadiene-isoprene copolymer rubber, and a butyl rubber. Further examples include natural rubber, an ethylene-propylene copolymer, and an ethylene-octene copolymer. One or more kinds of these polymer components are used.

When a polymer component other than the conjugated diene-based polymer of the present invention is incorporated with the invented polymer, the loading of the conjugated diene-based polymer of the present invention is preferably 10% by weight or more in order to improve fuel cost saving properties, and more preferably 20% by weight or more where 100% by weight of the total loading of the conjugated diene-based polymer and the other polymer component.

As the additives, known additives can be used, and examples thereof include vulcanization agents such as sulfur; vulcanization accelerators such as a thiazole-based vulcanization accelerator, a thiuram-based vulcanization accelerator, a sulfenamide-based vulcanization accelerator, and a guanidine-based vulcanization accelerator; vulcanization activating agents such as stearic acid and zinc oxide; organic peroxides such as dicumyl peroxide and di-tert-butyl peroxide; reinforcing agents such as silica and carbon black; fillers such as calcium carbonate, talc, alumina, clay, aluminum hydroxide, and mica; silane coupling agents; extender oils; processing aids; anti-aging agents; and lubricants.

Examples of the sulfur include powder sulfur, precipitated sulfur, colloidal sulfur, insoluble sulfur, and highly dispersible sulfur. The amount of the sulfur incorporated is preferably 0.1 parts by weight to 15 parts by weight, more preferably 0.3 parts by weight to 10 parts by weight, and even more preferably 0.5 parts by weight to 5 parts by weight, per 100 parts by weight of the polymer component.

Examples of the vulcanization accelerator include thiazole-based vulcanization accelerators such as 2-mercaptobenzothiazole, dibenzothiazyl disulfide, and N-cyclohexyl-2-benzothiazylsulfenamide; thiuram-based vulcanization accelerators such as tetramethylthiuram monosulfide and tetramethylthiuram disulfide; sulfenamide-based vulcanization accelerators such as N-cyclohexyl-2-benzothiazolesulfenamide, N-tert-butyl-2-benzothiazolesulfenamide, N-oxyethylene-2-benzothiazolesulfenamide, N-oxyethylene-2-benzothiazolesulfenamide, and N,N′-diisopropyl-2-benzothiazolesulfenamide; guanidine-based vulcanization accelerators such as diphenylguanidine, diorthotolylguanidine, and orthotolylbiguanidine. The amount of the vulcanization accelerator incorporated is preferably 0.1 parts by weight to 5 parts by weight, and more preferably 0.2 parts by weight to 3 parts by weight, per 100 parts by weight of the polymer component.

Examples of the silica include dry silica (silicic acid anhydride), wet silica (hydrous silicic acid), colloidal silica, precipitated silica, calcium silicate, and aluminum silicate. One or more kinds of them can be used. The BET specific surface area of silica is preferably 50 m²/g to 250 m²/g. The BET specific surface area is measured according to ASTM D1993-03. Examples of commercially available products that can be used include commercial name Ultrasil VN3-G, produced by Degussa, commercial name VN3, AQ, ER, and RS-150, produced by Tosoh Silica Corporation, and commercial name Zeosil 1115MP, 1165MP, produced by Rhodia.

Examples of the carbon black include furnace black, acetylene black, thermal black, channel black, and graphite. Examples of the carbon black include channel carbon black such as EPC, MPC and CC; furnace carbon black such as SAF, ISAF, HAF, MAF, FEF, SRF, GPF, APF, FF, CF, SCF and ECF; thermal carbon black such as FT and MT; and acetylene carbon black. One or more kinds of them can be used.

The nitrogen adsorption specific surface area (N₂SA) of carbon black is preferably 5 m²/g to 200 m²/g, and the dibutyl phthalate (DBP) absorption amount of carbon black is preferably 5 ml/100 g to 300 ml/100 g. The nitrogen adsorption specific surface area is measured according to ASTM D4820-93. The DBP absorption amount is measured according to ASTM D2414-93. Examples of commercially available products that can be used include commercial name Diablack N339, manufactured by Mitsubishi Chemical Corporation, commercial name SEAST 6, SEAST 7HM, and SEAST KH, produced by Tokai Carbon Co., Ltd., and commercial name CK 3, Special Black 4A, produced by Degussa.

When forming a conjugated diene-based polymer composition in which a reinforcing agent has been incorporated with the conjugated diene-based polymer of the present invention, the amount of the reinforcing agent incorporated is preferably 10 parts by weight to 150 parts by weight per 100 parts by weight of the conjugated diene-based polymer of the present invention. In order to enhance abrasion resistance and strength, the incorporated amount is more preferably 20 parts by weight or more, and even more preferably 30 parts by weight or more. In order to enhance reinforcing properties, the amount incorporated is more preferably 120 parts by weight or less, and even more preferably 100 parts by weight or less.

When forming a conjugated diene-based polymer composition in which a reinforcing agent has been incorporated with the conjugated diene-based polymer of the present invention, it is preferable to use silica as the reinforcing agent in order to improve fuel cost saving properties. The amount of silica incorporated is preferably 50 parts by weight or more, and more preferably 70 parts by weight or more, per 100 parts by weight of the total amount of the reinforcing agent incorporated.

The weight ratio of the content of silica used as the reinforcing agent and the content of carbon black (the content of silica:the content of carbon black) is preferably 2:1 to 50:1. In order to improve fuel cost saving properties and reinforcing properties, the weight ratio is more preferably 5:1 to 20:1.

Examples of the silane coupling agent include vinyltrichlorosilane, vinyltriethoxysilane, vinyltris(β-methoxyethoxy)silane, β-(3,4-epoxycyclohexyl)ethyltrimethoxysilane, γ-glycidoxypropyltrimethoxysilane, γ-methacryloxypropyltrimethoxysilane, N-(β-aminoethyl)-γ-aminopropyltrimethoxysilane, N-(β-aminoethyl)-γ-aminopropylmethyldimethoxysilane, N-phenyl-γ-aminopropyltrimethoxysilane, γ-chloropropyltrimethoxysilane, γ-mercaptopropyltrimethoxysilane, γ-aminopropyltriethoxysilane, bis(3-(triethoxysilyl)propyl)disulfide, bis(3-(triethoxysilyl)propyl)tetrasulfide, γ-trimethoxysilylpropyldimethylthiocarbamyl tetrasulfide, and γ-trimethoxysilylpropylbenzothiazyl tetrasulfide. One or more kinds of them are used. Examples of commercially available products that can be used include commercial name Si69, Si75, produced by Degussa.

When forming a conjugated diene-based polymer composition in which a silane coupling agent has been incorporated with the conjugated diene-based polymer of the present invention, the amount of the silane coupling agent incorporated is preferably 1 part by weight to 20 parts by weight, more preferably 2 parts by weight to 15 parts by weight, and even more preferably 5 parts by weight to 10 parts by weight, per 100 parts by weight of the silica.

Examples of the extender oil include aromatic-based mineral oils (viscosity gravity constant (V.G.C. value): 0.900 to 1.049), naphthene-based mineral oils (V.G.C. value: 0.850 to 0.899), and paraffin-based mineral oils (V.G.C. value: 0.790 to 0.849). The content of a polycyclic aromatic compound in the extender oil is preferably less than 3% by weight, and more preferably less than 1% by weight. The polycyclic aromatic content is measured according to the British Institute of Petroleum 346/92 Method. The content of an aromatic compound (CA) in the extender oil is preferably 20% by weight or more. One or more kinds of these extender oils are used.

A publicly known method, for example, a method of kneading each components with a known mixer such as a roll mixer and a Banbury mixer, can be used as a method for producing a conjugated diene-based polymer composition by incorporating other polymer components and additives with the conjugated diene-based polymer of the present invention.

Examples of a method for producing a conjugated diene-based polymer composition comprising a conjugated diene-based polymer and a reinforcing agent include a method of kneading the conjugated diene-based polymer and the reinforcing agent.

As kneading condition, when additives other than the vulcanization agent and the vulcanization accelerator are incorporated, the kneading temperature is usually 50° C. to 200° C., and preferably 80° C. to 190° C., and the kneading time is usually 30 seconds to 30 minutes, preferably 1 minute to 30 minutes. When the vulcanization agent and the vulcanization accelerator are incorporated, the kneading temperature is usually 100° C. or lower, preferably room temperature to 80° C. A composition in which a vulcanization agent and a vulcanization accelerator are incorporated is usually used after having been subjected to vulcanization treatment such as press vulcanization. The vulcanizing temperature is usually 1200° C. to 200° C., and preferably 140° C. to 180° C.

The conjugated diene-based polymer composition of the present invention is superior in fuel cost saving properties and is suitably used for tires.

### EXAMPLES

The evaluation of physical properties was performed by the following methods.

### 1. Mooney Viscosity (ML₁₊₄)

According to JIS K6300 (1994), the Mooney viscosity of a polymer was measured at 100° C.

### 2. Vinyl Bonding Amount (Unit: mol %)

The vinyl bonding amount of a polymer was obtained from the absorption intensity around 910 cm⁻¹, which is an absorption peak of a vinyl group, by an infrared spectrometric method.

3. Content of Structural Units Derived from Styrene (Unit: % by Weight)

According to JIS K6383 (1995), the content of structural units derived from styrene in a polymer was obtained from a refractive index.

### 4. Fuel Cost Saving Property

A strip-like test piece having a width of 1 mm or 2 mm and a length of 40 mm was punched out from a sheet-like vulcanization molded article, and was subjected to a test. For measurement, loss tangent (tan δ (70° C.)) of a test piece at a temperature of 70° C. was measured with a viscoelasticity measuring apparatus (manufactured by Ueshima Seisakusho Co., Ltd.) under the conditions of a strain of 1% and a frequency of 10 Hz. As this value is smaller, fuel cost saving properties are more excellent.

### Example 1

A polymerization reactor made of stainless steel equipped with a stirring device of an internal volume of 30 L was washed, dried, and the gas within the polymerization reactor was replaced with dry nitrogen. Then, 15.3 kg of industrial hexane (density: 680 kg/m³), 912 g of 1,3-butadiene, 288 g of styrene, 4.55 g of a mixture of 4-[2-(1-pyrrolidinyl)ethyl]styrene and 3-[2-(1-pyrrolidinyl)ethyl]styrene, 9.1 ml of tetrahydrofuran, and 7.1 ml of ethylene glycol diethyl ether were placed into the polymerization reactor. Then, in order to detoxify impurities causing inactivation of a polymerization initiator in advance, a small amount of a solution of n-butyllithium in n-hexane as a scavenger was charged into the polymerization reactor.

The polymerization reactor was charged with 22.6 mmol of a compound obtained by reacting 3-(dimethylamino)propyllithium and isoprene [reaction ratio: isoprene/3-(dimethylamino)propyllithium=2/1 (molar ratio), commercial name: AI-200CE2 (cyclohexane solution), produced by FMC] (hereinafter referred also as Compound (W)) as a cyclohexane solution, thereby initiating a polymerization reaction was initiated.

The polymerization reaction was carried out for 3 hours. During the polymerization reaction, the temperature within the polymerization reactor was adjusted to 65° C., the solution in the polymerization reactor was stirred at a stirring speed of 130 rpm, and 1368 g of 1,3-butadiene and 432 g of styrene were fed continuously into the polymerization reactor. Then, 25 minutes after the charging of Compound (W) into the polymerization reactor, 20 mL of a hexane solution containing 4.85 g of bis(diethylamino)methylvinylsilane was charged rapidly into the polymerization reactor, and 80 minutes after the charging of Compound (W) into the polymerization reactor, 20 mL of a hexane solution containing 4.55 g of a mixture of 4-[2-(1-pyrrolidinyl)ethyl]styrene and 3-[2-(1-pyrrolidinyl)ethyl]styrene was charged rapidly into the polymerization reactor. The sum total of the amount of the 4-[2-(1-pyrrolidinyl)ethyl]styrene charged and the amount of the 3-[2-(1-pyrrolidinyl)ethyl]styrene charged was 0.30% by weight where the overall amount of the monomers that had been charged or supplied into the polymerization reactor is taken as 100% by weight, and the amount of the bis(diethylamino)methylvinylsilane charged was 0.16% by weight.

Into the polymerization reactor was charged 22.6 mmol of N-(3-dimethylaminopropyl)acrylamide, and the resulting polymer solution was stirred for 15 minutes. Subsequently, 20 ml of a hexane solution containing 1.8 ml of methanol was charged into the polymerization reactor, and the resulting polymer solution was stirred for 5 minutes.

The polymerization reactor was charged with 12.0 g of 2-tert-butyl-6-(3-tert-butyl-2-hydroxy-5-methylbenzyl)-4-methylphenyl acrylate (produced by Sumitomo Chemical Co., Ltd., commercial name: Sumilizer GM) and 6.0 g of pentaerythrityl tetrakis(3-laurylthiopropionate) (produced by Sumitomo Chemical Co., Ltd., commercial name: Sumilizer TP-D), and subsequently the resulting polymer solution was distilled up at room temperature in 24 hours, and further dried under reduced pressure at 55° C. for 12 hours, affording a polymer. The evaluation results of the polymer are shown in Table 1.

One hundred parts by weight of the resulting polymer, 78.4 parts by weight of silica (commercial name: Ultrasil VN3-G, manufactured by Degussa), 6.4 parts by weight of a silane coupling agent (commercial name: Si69, manufactured by Degussa), 6.4 parts by weight of carbon black (commercial name: Diablack N339, manufactured by Mitsubishi Chemical Corporation), 47.6 parts by weight of an extender oil (commercial name: JOMO Process NC-140, manufactured by Japan Energy Corporation), 1.5 parts by weight of an anti-aging agent (commercial name: Antigen 3C, manufactured by Sumitomo Chemical Co., Ltd.), 2 parts by weight of stearic acid, 2 parts by weight of zinc flower, 1 part by weight of a vulcanization accelerator (commercial name: Soxinol CZ, manufactured by Sumitomo Chemical Co., Ltd.), 1 part by weight of a vulcanization accelerator (commercial name: Soxinol D, manufactured by Sumitomo Chemical Co., Ltd.), 1.5 parts by weight of a wax (commercial name: Sunnoc N, manufactured by Ouchi Shinko Chemical Industrial Co., Ltd.), and 1.4 parts by weight of sulfur were kneaded with Laboplast Mill to prepare a polymer composition. The resulting polymer composition was molded into a sheet with a 6 inch roll, and the sheet was heated at 160° C. for 45 minutes to vulcanize, thereby preparing a vulcanized sheet. The evaluation results of physical properties of the vulcanized sheet are shown in Table 1.

### Example 2

A polymerization reactor made of stainless steel equipped with a stirring device of an internal volume of 20 L was washed, dried, and the gas within the polymerization reactor was replaced by dry nitrogen. Then, 10.2 kg of industrial hexane (density: 680 kg/m³), 608 g of 1,3-butadiene, 192 g of styrene, 2.95 g of a mixture of 4-[2-(1-pyrrolidinyl)ethyl]styrene and 3-[2-(1-pyrrolidinyl)ethyl]styrene, 6.1 ml of tetrahydrofuran, and 4.7 ml of ethylene glycol diethyl ether were placed into the polymerization reactor. Then, in order to detoxify impurities causing inactivation of a polymerization initiator in advance, a small amount of a solution of n-butyllithium in n-hexane as a scavenger was charged into the polymerization reactor.

The polymerization reactor was charged with 14.7 mmol of a compound obtained by reacting 3-(dimethylamino)propyllithium and isoprene [reaction ratio: isoprene/3-(dimethylamino)propyllithium=2/1 (molar ratio), commercial name: AI-200CE2 (cyclohexane solution), produced by FMC] (Compound (W)) as a cyclohexane solution, thereby initiating a polymerization reaction.

The polymerization reaction was carried out for 3 hours. During the polymerization reaction, the temperature within the polymerization reactor was adjusted to 65° C., the solution in the polymerization reactor was stirred at a stirring speed of 130 rpm, and 912 g of 1,3-butadiene and 288 g of styrene were fed continuously into the polymerization reactor. Then, 25 minutes after the charging of Compound (W) into the polymerization reactor, 20 mL of a hexane solution containing 1.57 g of bis(diethylamino)methylvinylsilane was charged rapidly into the polymerization reactor. 80 minutes after the charging of Compound (W) into the polymerization reactor, 20 mL of a hexane solution containing 2.95 g of a mixture of 4-[2-(1-pyrrolidinyl)ethyl]styrene and 3-[2-(1-pyrrolidinyl)ethyl]styrene was charged rapidly into the polymerization reactor. The sum total of the amount of the 4-[2-(1-pyrrolidinyl)ethyl]styrene charged and the amount of the 3-[2-(1-pyrrolidinyl)ethyl]styrene charged was 0.29% by weight where the overall amount of the monomers that had been charged or supplied into the polymerization reactor is taken as 100% by weight, and the amount of the bis(diethylamino)methylvinylsilane charged was 0.078% by weight.

Into the polymerization reactor was charged 14.7 mmol of N-(3-dimethylaminopropyl)acrylamide, and the resulting polymer solution was stirred for 15 minutes. Subsequently, 20 ml of a hexane solution containing 1.2 ml of methanol was charged into the polymerization reactor, and the resulting polymer solution was stirred for 5 minutes.

The polymerization reactor was charged with 8.0 g of 2-tert-butyl-6-(3-tert-butyl-2-hydroxy-5-methylbenzyl)-4-methylphenyl acrylate (produced by Sumitomo Chemical Co., Ltd., commercial name: Sumilizer GM) and 4.0 g of pentaerythrityl tetrakis(3-laurylthiopropionate) (produced by Sumitomo Chemical Co., Ltd., commercial name: Sumilizer TP-D), and subsequently the resulting polymer solution was distilled up at room temperature in 24 hours, and further dried under reduced pressure at 55° C. for 12 hours, affording a polymer. The evaluation results of the polymer are shown in Table 1.

One hundred parts by weight of the resulting polymer, 78.4 parts by weight of silica (commercial name: Ultrasil VN3-G, manufactured by Degussa), 6.4 parts by weight of a silane coupling agent (commercial name: Si69, manufactured by Degussa), 6.4 parts by weight of carbon black (commercial name: Diablack N339, manufactured by Mitsubishi Chemical Corporation), 47.6 parts by weight of an extender oil (commercial name: JOMO Process NC-140, manufactured by Japan Energy Corporation), 1.5 parts by weight of an anti-aging agent (commercial name: Antigen 3C, manufactured by Sumitomo Chemical Co., Ltd.), 2 parts by weight of stearic acid, 2 parts by weight of zinc flower, 1 part by weight of a vulcanization accelerator (commercial name: Soxinol CZ, manufactured by Sumitomo Chemical Co., Ltd.), 1 part by weight of a vulcanization accelerator (commercial name: Soxinol D, manufactured by Sumitomo Chemical Co., Ltd.), 1.5 parts by weight of a wax (commercial name: Sunnoc N, manufactured by Ouchi Shinko Chemical Industrial Co., Ltd.), and 1.4 parts by weight of sulfur were kneaded with Laboplast Mill to prepare a polymer composition. The resulting polymer composition was molded into a sheet with a 6 inch roll, and the sheet was heated at 160° C. for 45 minutes to vulcanize, thereby preparing a vulcanized sheet. The evaluation results of physical properties of the vulcanized sheet are shown in Table 1.

### Comparative Example 1

A polymerization reactor made of stainless steel equipped with a stirring device of an internal volume of 20 L was washed, dried, and the gas within the polymerization reactor was replaced by dry nitrogen. Then, 10.2 kg of industrial hexane (density 680 kg/m³), 608 g of 1,3-butadiene, 192 g of styrene, 6.1 ml of tetrahydrofuran, and 4.4 ml of ethylene glycol diethyl ether were placed into the polymerization reactor. Then, in order to detoxify impurities causing inactivation of a polymerization initiator in advance, a small amount of a solution of n-butyllithium in n-hexane as a scavenger was charged into the polymerization reactor.

The polymerization reactor was charged with 2.63 g of bis(diethylamino)methylvinylsilane and then with a n-hexane solution of n-butyllithium (the content of n-butyllithium: 12.3 mmol), thereby initiating a polymerization reaction.

The polymerization reaction was carried out for 3 hours. During the polymerization reaction, the temperature within the polymerization reactor was adjusted to 65° C., the solution in the polymerization reactor was stirred at a stirring speed of 130 rpm, and 912 g of 1,3-butadiene and 288 g of styrene were fed continuously into the polymerization reactor. The amount of the bis(diethylamino)methylvinylsilane charged was 0.13% by weight where the overall amount of the monomers that had been charged or supplied into the polymerization reactor is taken as 100% by weight.

Subsequently, 20 ml of a hexane solution containing 0.8 ml of methanol was charged into the polymerization reactor, and the resulting polymer solution was stirred for 5 minutes.

The polymerization reactor was charged with 8.0 g of 2-tert-butyl-6-(3-tert-butyl-2-hydroxy-5-methylbenzyl)-4-methylphenyl acrylate (produced by Sumitomo Chemical Co., Ltd., commercial name: Sumilizer GM) and 4.0 g of pentaerythrityl tetrakis(3-laurylthiopropionate) (produced by Sumitomo Chemical Co., Ltd., commercial name: Sumilizer TP-D), and subsequently the resulting polymer solution was distilled up at room temperature in 24 hours, and further dried under reduced pressure at 55° C. for 12 hours, affording a polymer. The evaluation results of the polymer are shown in Table 1.

One hundred parts by weight of the resulting polymer, 78.4 parts by weight of silica (commercial name: Ultrasil VN3-G, manufactured by Degussa), 6.4 parts by weight of a silane coupling agent (commercial name: Si69, manufactured by Degussa), 6.4 parts by weight of carbon black (commercial name: Diablack N339, manufactured by Mitsubishi Chemical Corporation), 47.6 parts by weight of an extender oil (commercial name: JOMO Process NC-140, manufactured by Japan Energy Corporation), 1.5 parts by weight of an anti-aging agent (commercial name: Antigen 3C, manufactured by Sumitomo Chemical Co., Ltd.), 2 parts by weight of stearic acid, 2 parts by weight of zinc flower, 1 part by weight of a vulcanization accelerator (commercial name: Soxinol CZ, manufactured by Sumitomo Chemical Co., Ltd.), 1 part by weight of a vulcanization accelerator (commercial name: Soxinol D, manufactured by Sumitomo Chemical Co., Ltd.), 1.5 parts by weight of a wax (commercial name: Sunnoc N, manufactured by Ouchi Shinko Chemical Industrial Co., Ltd.), and 1.4 parts by weight of sulfur were kneaded with Laboplast Mill to prepare a polymer composition. The resulting polymer composition was molded into a sheet with a 6 inch roll, and the sheet was heated at 160° C. for 45 minutes to vulcanize, thereby preparing a vulcanized sheet. The evaluation results of physical properties of the vulcanized sheet are shown in Table 1.

### Comparative Example 2

A polymerization reactor made of stainless steel equipped with a stirring device of an internal volume of 20 L was washed, dried, and the gas within the polymerization reactor was replaced by dry nitrogen. Then, 10.2 kg of industrial hexane (density: 680 kg/m³), 608 g of 1,3-butadiene, 192 g of styrene, 2.92 g of a mixture of 4-[2-(1-pyrrolidinyl)ethyl]styrene and 3-[2-(1-pyrrolidinyl)ethyl]styrene, 6.1 ml of tetrahydrofuran, and 4.7 ml of ethylene glycol diethyl ether were placed into the polymerization reactor. Then, in order to detoxify impurities causing inactivation of a polymerization initiator in advance, a small amount of a solution of n-butyllithium in n-hexane as a scavenger was charged into the polymerization reactor.

The polymerization reactor was charged with 14.5 mmol of a compound obtained by reacting 3-(dimethylamino)propyllithium and isoprene [reaction ratio: isoprene/3-(dimethylamino)propyllithium=2/1 (molar ratio), commercial name: AI-200CE2 (cyclohexane solution), produced by FMC] (Compound (W)) as a cyclohexane solution, thereby initiating a polymerization reaction.

The polymerization reaction was carried out for 3 hours. During the polymerization reaction, the temperature within the polymerization reactor was adjusted to 65° C., the solution in the polymerization reactor was stirred at a stirring speed of 130 rpm, and 912 g of 1,3-butadiene and 288 g of styrene were fed continuously into the polymerization reactor. Moreover, 80 minutes after the charging of Compound (W) into the polymerization reactor, 20 mL of a hexane solution containing 2.92 g of a mixture of 4-[2-(1-pyrrolidinyl)ethyl]styrene and 3-[2-(1-pyrrolidinyl)ethyl]styrene was charged rapidly into the polymerization reactor. After charging Compound (W) into the polymerization reactor, the sum total of the amount of the 4-[2-(1-pyrrolidinyl)ethyl]styrene charged and the amount of the 3-[2-(1-pyrrolidinyl)ethyl]styrene charged was 0.29% by weight where the overall amount of the monomers that had been charged or supplied into the polymerization reactor is taken as 100% by weight.

Into the polymerization reactor was charged 14.5 mmol of N-(3-dimethylaminopropyl)acrylamide, and the resulting polymer solution was stirred for 15 minutes. Subsequently, 20 ml of a hexane solution containing 1.2 ml of methanol was charged into the polymerization reactor, and the resulting polymer solution was stirred for 5 minutes.

The polymerization reactor was charged with 8.0 g of 2-tert-butyl-6-(3-tert-butyl-2-hydroxy-5-methylbenzyl)-4-methylphenyl acrylate (produced by Sumitomo Chemical Co., Ltd., commercial name: Sumilizer GM) and 4.0 g of pentaerythrityl tetrakis(3-laurylthiopropionate) (produced by Sumitomo Chemical Co., Ltd., commercial name: Sumilizer TP-D), and subsequently the resulting polymer solution was distilled up at room temperature in 24 hours, and further dried under reduced pressure at 55° C. for 12 hours, affording a polymer. The evaluation results of the polymer are shown in Table 1.

One hundred parts by weight of the resulting polymer, 78.4 parts by weight of silica (commercial name: Ultrasil VN3-G, manufactured by Degussa), 6.4 parts by weight of a silane coupling agent (commercial name: Si69, manufactured by Degussa), 6.4 parts by weight of carbon black (commercial name: Diablack N339, manufactured by Mitsubishi Chemical Corporation), 47.6 parts by weight of an extender oil (commercial name: JOMO Process NC-140, manufactured by Japan Energy Corporation), 1.5 parts by weight of an anti-aging agent (commercial name: Antigen 3C, manufactured by Sumitomo Chemical Co., Ltd.), 2 parts by weight of stearic acid, 2 parts by weight of zinc flower, 1 part by weight of a vulcanization accelerator (commercial name: Soxinol CZ, manufactured by Sumitomo Chemical Co., Ltd.), 1 part by weight of a vulcanization accelerator (commercial name: Soxinol D, manufactured by Sumitomo Chemical Co., Ltd.), 1.5 parts by weight of a wax (commercial name: Sunnoc N, manufactured by Ouchi Shinko Chemical Industrial Co., Ltd.), and 1.4 parts by weight of sulfur were kneaded with Laboplast Mill to prepare a polymer composition. The resulting polymer composition was molded into a sheet with a 6 inch roll, and the sheet was heated at 160° C. for 45 minutes to vulcanize, thereby preparing a vulcanized sheet. The evaluation results of physical properties of the vulcanized sheet are shown in Table 1.

TABLE 1

| | | Exam- | Exam- | Comparative | Comparative |
|---|---|---|---|---|---|
| | | ple 1 | ple 2 | Example 1 | Example 2 |
| Mooney | — | 41.4 | 50.2 | 40.9 | 43.6 |
| viscosity | | | | | |
| Amount of | mol % | 56.2 | 57.0 | 57.6 | 57.0 |
| vinyl binds | | | | | |
| Content of | % by | 24.0 | 24.5 | 24.4 | 24.3 |
| structural | weight | | | | |
| unit derived | | | | | |
| from styrene | | | | | |
| Fuel cost | — | 0.106 | 0.102 | 0.141 | 0.148 |
| saving | | | | | |
| property | | | | | |
| tanδ (70° C.) | | | | | |

### INDUSTRIAL APPLICABILITY

According to the present invention, there can be provided a method for producing a conjugated diene-based polymer useful for the preparation of a conjugated diene-based polymer composition excellent in fuel cost saving properties, and a method for producing a polymer composition containing a conjugated diene-based polymer obtained with this production method and a reinforcing agent.

1. A method for producing a conjugated diene-based polymer, comprising polymerizing monomer components including a compound represented by the following formula (2), a compound represented by the following formula (3) and a conjugated diene compound using a compound represented by the following formula (1), and then reacting a compound containing a nitrogen atom and/or a silicon atom to an active end of the polymer formed via the polymerization, 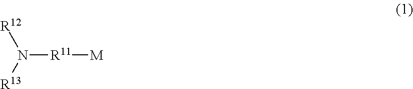
in formula (1), R¹¹ represents a hydrocarbylene group having 6 to 100 carbon atoms, R¹² and R¹³ each represent a hydrocarbyl group that optionally has a substituent or a trihydrocarbylsilyl group, or R¹² is bonded to R¹³ and the group in which R¹² is bonded to R¹³ represents a hydrocarbylene group optionally having a nitrogen atom and/or an oxygen atom as a hetero atom, a group having 5 to 20 carbon atoms represented by —Si(R¹⁴)₂—(CH₂)ₓ—Si(R¹⁴)₂—(R¹⁴ represents a hydrocarbyl group, and x represents an integer of 1 to 10), a group having 4 to 20 carbon atoms represented by —Si(R¹⁵)₂—(CH₂)_{y}— (R¹⁵ represents a hydrocarbyl group, and y represents an integer of 2 to 11), and M represents an alkali metal atom,
E²-A² (2)
wherein E² represents a hydrocarbyl group having a polymerizable carbon-carbon double bond, and A² represents a substituted amino group or a nitrogen-containing heterocyclic group,
E³-A³ (3)
wherein E³ represents a hydrocarbyl group having a polymerizable carbon-carbon double bond, and A³ represents a substituted silyl group.

2. The method for producing a conjugated diene-based polymer according to claim 1, wherein the total amount of the compound represented by formula (2) and the compound represented by formula (3) to be used in the polymerization is 0.02% by weight to 25% by weight where the overall amount of the monomer components to be used in the polymerization is taken as 100% by weight.

3. The method for producing a conjugated diene-based polymer according to claim 1, wherein the ratio of the weight of the compound represented by formula (2) to the weight of the compound represented by formula (3) to be used in the polymerization (the weight of the compound represented by formula (2)/the weight of the compound represented by formula (3)) is from 0.1 to 10.

4. The method for producing a conjugated diene-based polymer according to claim 1, wherein R¹¹ is a group represented by the following formula (1-A),
CH₂ₗR¹⁶— (1-A)
in formula (1-A), R¹⁶ represents a hydrocarbylene group comprised of a structural unit derived from a conjugated diene compound and/or a structural unit derived from an aromatic vinyl compound, and l represents an integer of 1 to 10.

5. The method for producing a conjugated diene-based polymer according to claim 4, wherein R¹⁶ is a hydrocarbylene group comprised of 1 unit to 10 units of structural units derived from isoprene.

6. The method for producing a conjugated diene-based polymer according to claim 1, wherein the compound represented by formula (2) is a compound represented by the following formula (2-1), 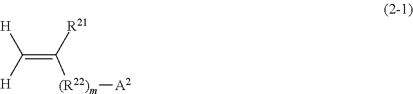
wherein R²¹ represents a hydrogen atom or a hydrocarbyl group, m represents an integer of 0 or 1, R²² represents a hydrocarbylene group, and A² represents a substituted amino group or a nitrogen-containing heterocyclic group.

7. The method for producing a conjugated diene-based polymer according to claim 1, wherein the compound represented by formula (3) is a compound represented by the following formula (3-1), 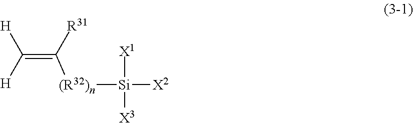
wherein R³¹ represents a hydrogen atom or a hydrocarbyl group, n represents an integer of 0 or 1, and R³² represents a hydrocarbylene group, wherein X¹, X² and X³ each independently represent a substituted amino group or a hydrocarbyl group optionally having a substituent, provided that at least one of X¹, X² and X³ is a substituted amino group.

8. A method for producing a conjugated diene-based polymer composition, comprising a step of kneading 100 part by weight of a conjugated diene-based polymer obtained by the method according to claim 1 with 10 parts by weight to 150 parts by weight of a reinforcing agent.

9. The method for producing a conjugated diene-based polymer according to claim 2, wherein the ratio of the weight of the compound represented by formula (2) to the weight of the compound represented by formula (3) to be used in the polymerization (the weight of the compound represented by formula (2)/the weight of the compound represented by formula (3)) is from 0.1 to 10.
